(19) United States
(12) Patent Application Publication
(10) Pub. No.: US 2018/0025500 A1
(43) Pub. Date: Jan. 25, 2018

(54) METHOD OF TRACKING ONE OR MORE MOBILE OBJECTS IN A SITE AND A SYSTEM EMPLOYING SAME

(71) Applicant: APPROPOLIS INC., Calgary (CA)

(72) Inventors: Jorgen S. NIELSEN, Calgary (CA); Christopher S. NIELSEN, Calgary (CA); Zhe HE, Calgary (CA)

(21) Appl. No.: 15/656,428

(22) Filed: Jul. 21, 2017

Related U.S. Application Data
(60) Provisional application No. 62/365,825, filed on Jul. 22, 2016.

(51) Int. Cl. G06T 7/277; G06K 9/00; G01S 5/02; G06T 7/73; G06K 9/62; G06T 7/254; H04N 7/18

(52) U.S. Cl. CPC G06T 7/277; G06T 7/254; G06K 9/00664; H04N 7/181; G06T 7/74; G06K 9/6278; G01S 5/0252; G01S 5/0294; G01S 5/0263; G06T 2207/30241; G06T 2207/30201; G06T 2207/10016; G06K 2209/27

(57) ABSTRACT

A mobile object tracking system has one or more imaging devices for capturing images of a site, one or more reference wireless devices in wireless communication with one or more mobile wireless devices (MWDs) via one or more wireless signals, and one or more received signal strength models (RSSMs) of the site for the wireless signals. Each MWD is associated with a mobile object and movable therewith. The system tracks the mobile objects by combining the captured images, the received signal strength (RSS) observables of the wireless signals, and the RSSMs. The system may calibrate the RSSMs at an initial stage and during mobile object tracking.

### CROSS-REFERENCE TO RELATED APPLICATIONS

This application claims the benefit of U.S. Provisional Patent Application Ser. No. 62/365,825, filed Jul. 22, 2016, the content of which is incorporated herein by reference in its entirety.

This application is also related to U.S. patent application Ser. No. 14/997,977, filed Jan. 18, 2016, the content of which is incorporated herein by reference in its entirety.

### FIELD OF THE DISCLOSURE

Embodiments herein relate generally to a system and a method of indoor location estimation based on receiver signal strength (RSS) observables, and in particular to a system and a method of automated generation and maintenance of wireless RSS radio maps using crowd-sourcing.

### BACKGROUND

Location-based services (LBS) have been used in indoor (such as a building or the like) or outdoor (such as a campus or the like) environments. LBS provide services for detecting, tracking and identifying movable objects as they move in a site such as a building complex. With more and more imaging devices such as security cameras deployed in such buildings, imaging devices with computer vision (CV) processing can be used to track movable objects. Known CV algorithms can provide some degree of identification of the movable object by using methods such as object classification, human recognition, and height and facial attributes recognition. However, identification based on CV processing alone may not be sufficiently reliable. Therefore, in some systems, such as in a system disclosed in Applicant's U.S. patent application Ser. No. 14/997,977, at least some movable objects carry Mobile Wireless Devices (MWDs) for facilitating object tracking. Such systems combine CV observations and MWD observations for positive identification. The MWD typically has a set of sensors such as received signal strength (RSS) scanners of available wireless signals, accelerometers, rate gyros, and barometers. Sensor signals measured by the MWD can be bundled into a data packet and sent wirelessly to the network.

RSS observables and/or wireless signal measurements may be used for determining the location of a wireless device in indoor and outdoor navigation. With general wireless data communication becoming widely available in public and commercial buildings, RSS observables are becoming more and more important in LBS.

A problem is that a navigation system using RSS requires tedious calibration in the form of RSS surveys of the building complex to build a parameterized RSS model or a radio map of coefficients for a non-parameterized model. The radio map approach is generally referred to as fingerprinting.

### SUMMARY

According to one aspect of this disclosure, there is provided a method for tracking one or more mobile objects in a site such as a building complex or a campus area by using one or more imaging devices and one or more mobile wireless devices, each of the one or more mobile wireless devices being associated and movable with a mobile object and in wireless communication with one or more reference wireless devices such as wireless access points (APs) via one or more wireless signals. One or more receiver signal strength models (RSSMs) of the one or more wireless signals are also used for tracking the mobile objects.

A RSSM is a model approximating the RSS of a wireless signal that a receiver in the site would observe. In various embodiments, the RSSMs may be parametric RSSMs, nonparametric RSSMs, or a combination thereof. A nonparametric RSSM may comprise one or more radio maps. The parameters required for the parametric RSSMs and data of the radio maps may be determined by RSSM calibration. In some embodiments, RSSM calibration comprises two phases or modes including an initial survey or calibration mode and a crowd-sourcing maintenance survey or calibration mode.

In the initial calibration mode, a mobile object and a mobile wireless device that are known to be associated through the initial calibration may be used.

The maintenance calibration mode may be conducted in parallel with mobile object tracking. When a mobile object is paired or associated with a mobile wireless device, a crowd-sourced maintenance calibration event may be triggered.

In some embodiments, a set of diagnostic tools may be implemented using the RSSMs for verifying the sufficiency of the RSS observables with respect to some location accuracy criteria.

In some embodiments, the method uses a radio-map weight matrix to determine the quality of current RSSM. In some embodiments, the method also uses the aging of RSSM in determining the quality of current RSSM.

According to one aspect of this disclosure, there is provided a system for tracking at least one mobile object in a site. The system comprises: (i) one or more imaging devices each capturing images of at least a portion of the site; (ii) one or more reference wireless devices; (iii) one or more mobile wireless devices (MWDs) in wireless communication with the one or more reference wireless devices via one or more wireless signals, each of the one or more MWDs being associated with one of the at least one mobile object and movable therewith; and (iv) at least one processing structure functionally coupled to the one or more imaging devices, the one or more reference wireless devices, and the one or more MWDs.

The at least one processing structure acts for: maintaining one or more received signal strength models (RSSMs) of the site for the one or more wireless signals; obtaining received signal strength (RSS) observables of the one or more wireless signals; and tracking the at least one mobile object by combining the captured images, the obtained RSS observables, and the one or more RSSMs.

In some embodiments of the system, each of the one or more RSSMs is any one or a combination of a parametric RSSM and a nonparametric RSSM, and each nonparametric RSSM comprises a radio map of the site for one of the one or more wireless signals.

In some embodiments of the system, said tracking the at least one mobile object comprises: detecting the at least one mobile object based on the captured images; determining a trajectory for each of the detected at least one mobile object based on the captured images; determining a trajectory for each of the one or more MWDs based on the obtained RSSM observables and the one or more RSSMs; and associating each of the one or more MWDs with one of the detected at least one mobile object if a probability of association (PoA) between the trajectory of the MWD and the trajectory of the mobile object is greater than a threshold.

In some embodiments of the system, the PoA between the trajectory of the MWD and the trajectory of the mobile object is calculated by evaluating the similarity therebetween.

In some embodiments of the system, the PoA between the trajectory of the MWD and the trajectory of the mobile object is calculated by using the Kullback Leibler Distance between the two trajectories.

In some embodiments of the system, said determining the trajectory for each of the detected at least one mobile object based on the captured images comprises: determining the trajectory for each of the detected at least one mobile object using a Bayesian model based on the captured images.

In some embodiments, the system comprises a plurality of imaging devices, wherein at least a first and a second ones of the plurality of imaging devices are respectively associated with two main field of view (FOV) areas, and the two main FOV areas are non-overlapped with an estimation area therebetween. Said determining the trajectory for each of the detected at least one mobile object based on the captured images comprises, for each of the detected at least one mobile object: calculating the position of the mobile object by projecting the mobile object from a plane of the captured images into a coordinate system of the site; if the calculated position of the mobile object is within the estimation area, recalculating the position of the mobile object by using a spatial interpolation method; and determining the trajectory for the mobile object.

In some embodiments of the system, the at least one processing structure further acts for: updating the one or more RSSMs using the location of the mobile object and the RSS observables of the MWD, after associating one of the one or more MWDs with one of the at least one mobile object.

In some embodiments of the system, the at least one processing structure further acts for: identifying, from the at least one mobile object and the one or more MWDs, at least one pair of associated mobile object and MWD movable in the site, said association between each of the at least one pair of associated mobile object and MWD being maintained through a calibration period; and building the one or more RSSMs based on the locations of the identified mobile objects and the RSS observables of the identified MWDs.

In some embodiments of the system, said identifying at least one pair of associated mobile object and MWD comprises: allowing only one of the at least one mobile object movable in the site, one of the one or more MWDs being associated with said only one mobile object and movable therewith.

In some embodiments of the system, the at least one processing structure further acts for: moving said identified at least one pair of associated mobile object and MWD in the site along a survey path.

In some embodiments of the system, the site is partitioned into a two-dimensional (2D) matrix of grid points, and the at least one processing structure further acts for: calculating a set of location weights using a Gaussian kernel and the location of the mobile object; calculating a radio-map weight matrix using the calculated set of location weights, each radio-map weight being associated with a location of the site; and calculating a radio-map value matrix using the obtained RSSM observables obtained at the location of the mobile object.

In some embodiments of the system, said calculating the set of location weights comprises calculating the set of location weights using the Gaussian kernel, the location of the mobile object, and a RSS quality factor.

In some embodiments of the system, the RSS quality factor has a value greater than one at the locations within the FOV of one of the imaging device and in proximity therewith.

In some embodiments of the system, the RSS quality factor has a value smaller than one at the locations at a distance from one of the imaging device.

In some embodiments of the system, the RSS quality factor is a function of the grid points.

In some embodiments of the system, said updating the one or more RSSMs using the location of the mobile object and the RSS observables of the MWD comprises: updating the one or more RSSMs using the location of the mobile object and the RSS observables of the MWD if the radio-map weight associated with the location of the mobile object is greater than a weight-acceptance threshold.

In some embodiments of the system, the at least one processing structure further acts for: calculating the Fisher Information between one of the one or more MWDs and the one or more reference wireless devices for determining estimated deviation of location estimate of the MWD based on the obtained RSS observables.

In some embodiments of the system, said calculating the Fisher Information is further based on the obtained the observables of an inertial measurement unit of the MWD.

In some embodiments of the system, the at least one processing structure further acts for: using the calculated Fisher Information for determining deviation of sufficiency of the one or more wireless signals used for obtaining RSS observables thereof.

In some embodiments of the system, the at least one processing structure further acts for: using the calculated Fisher Information for determining contribution of each of the one or more wireless signals in the obtained RSS observables.

According to one aspect of this disclosure, there is provided a method of tracking at least one mobile object in a site. The method comprises: maintaining one or more received signal strength models (RSSMs) of the site for one or more wireless signals transmitted between one or more mobile wireless devices (MWDs) and one or more reference wireless devices, each of the one or more MWDs being associated with one of the at least one mobile object and movable therewith; obtaining received signal strength (RSS) observables of the one or more wireless signals; capturing images of at least a portion of the site; and tracking the at least one mobile object by combining the captured images, the obtained RSS observables, and the one or more RSSMs.

In some embodiments of the method, each of the one or more RSSMs is any one or a combination of a parametric RSSM and a nonparametric RSSM, and each nonparametric RSSM comprises a radio map of the site for one of the one or more wireless signals.

In some embodiments of the method, said tracking the at least one mobile object comprises: detecting the at least one mobile object based on the captured images; determining a trajectory for each of the detected at least one mobile object based on the captured images; determining a trajectory for each of the one or more MWDs based on the obtained RSSM observables and the one or more RSSMs; and associating each of the one or more MWDs with one of the detected at least one mobile object if a probability of association (PoA) between the trajectory of the MWD and the trajectory of the mobile object is greater than a threshold.

In some embodiments of the method, said determining the trajectory for each of the detected at least one mobile object based on the captured images comprises: determining the trajectory for each of the detected at least one mobile object using a Bayesian model based on the captured images.

In some embodiments of the method, said determining the trajectory for each of the detected at least one mobile object based on the captured images comprises, for each of the detected at least one mobile object: calculating the position of the mobile object by projecting the mobile object from a plane of the captured images into a coordinate system of the site; determining if the calculated position of the mobile object is within an estimation area between two non-overlapped main FOV areas; if the calculated position of the mobile object is within the estimation area, recalculating the position of the mobile object by using a spatial interpolation method; and determining the trajectory for the mobile object.

In some embodiments, the method further comprises: updating the one or more RSSMs using the location of the mobile object and the RSS observables of the MWD, after associating one of the one or more MWDs with one of the at least one mobile object.

In some embodiments, the method further comprises: identifying, from the at least one mobile object and the one or more MWDs, at least one pair of associated mobile object and MWD movable in the site, said association between each of the at least one pair of associated mobile object and MWD being maintained through a calibration period; and building the one or more RSSMs based on the locations of the identified mobile objects and the RSS observables of the identified MWDs.

In some embodiments of the method, said identifying at least one pair of associated mobile object and MWD comprises: allowing only one of the at least one mobile object movable in the site, one of the one or more MWDs being associated with said only one mobile object and movable therewith.

In some embodiments, the method further comprises: moving said identified at least one pair of associated mobile object and MWD in the site along a survey path.

In some embodiments of the method, the site is partitioned into a two-dimensional (2D) matrix of grid points, and the method further comprises: calculating a set of location weights using a Gaussian kernel and the location of the mobile object; calculating a radio-map weight matrix using the calculated set of location weights; and calculating a radio-map value matrix using the obtained RSSM observables obtained at the location of the mobile object.

In some embodiments of the method, said updating the one or more RSSMs using the location of the mobile object and the RSS observables of the MWD comprises: updating the one or more RSSMs using the location of the mobile object and the RSS observables of the MWD if the radio-map weight associated with the location of the mobile object is greater than a weight-acceptance threshold.

### BRIEF DESCRIPTION OF THE DRAWINGS

FIG. 1 is a schematic diagram of a Mobile Location System (MLS) for tracking one or more moving objects and one or more mobile wireless devices each associated and movable with a moving object, according to some embodiments of this disclosure;

FIG. 2 is a schematic plan view of a site of the MLS system shown in FIG. 1;

FIG. 3 is a schematic plan view of a floor space of a site that is partitioned into a matrix of two-dimensional (2D) grid points with a constant grid spacing;

FIG. 4 is a schematic diagram showing a software structure of the MLS system shown in FIG. 1;

FIGS. 5A to 5C show an example of computer vision (CV) processing conducted in the CV processing block shown in FIG. 4;

FIG. 6 shows an example of a building map of a site;

FIG. 7A shows three source images captured by the two imaging devices shown in FIG. 6;

FIG. 7B shows the foreground mask images obtained from source images shown in FIG. 7A;

FIG. 7C shows the images shown in FIG. 7A with bounding boxes added about the CV objects detected therein;

FIG. 8 shows an example of tracking a moving object walking along a path in the site shown in FIG. 6;

FIG. 9 shows the error variance distribution of the estimated points obtained in the moving object tracking shown in FIG. 8;

FIG. 10 is a flowchart showing the steps of a process of an initial calibration mode;

FIG. 11 is a flowchart showing the steps of a maintenance calibration process of the MLS system shown in FIG. 1;

FIG. 12 shows an example of a portion of a 2D grid system for a floor space;

FIG. 13 shows a portion of a survey path in a floor space for an initial RSSM calibration and corresponding weight-acceptance threshold lines;

FIG. 14 shows an example of a room having a single imaging device, wherein the field of view of the imaging device is partitioned into a proximal area and a distal area;

FIG. 15 shows an example of using trained MWD data for improving the accuracy of moving object trajectory estimate;

FIG. 16 is a plane view of a test floor space for testing the MLS system shown in FIG. 1;

FIG. 17 is a contour plot showing the contour of the radio-map weights W_{i,j} of a Bluetooth® beacon in the test floor space shown in FIG. 16;

FIG. 18 is a contour plot of a radio map of a Bluetooth® beacon in the test floor space shown in FIG. 16; and

FIG. 19 is a schematic diagram of a MLS for tracking one or more moving objects and one or more mobile wireless devices each associated and movable with a moving object, according to some alternative embodiments of this disclosure.

### DETAILED DESCRIPTION

### Glossary

Below is a table listing some acronyms used in this disclosure:

| ACRONYM | DESCRIPTION |
|---|---|
| AP | Access Point |
| BM | Building Map |
| CV | Computer Vision |
| CVO | CV Object |
| FI | Fisher Information |
| FOV | Field Of View |
| ImD | Imaging Device |
| IMU | Inertial Measurement Unit (comprising accelerometers and |
| | rate gyros) |
| MA | Mobile Agent |
| MLS | Mobile Location System |
| MWD | Mobile Wireless Device (such as smartphone, tablet, tag |
| | device, and the like, associated with a mobile object) |
| MWO | Mobile Wireless Object |
| PoA | Probability of Association (between a MA and a MWD) |
| RF | Radio Frequency |
| RSS | Receiver Signal Strength |
| RSSM | RSS Model, generalization of the parameterized or non- |
| | parameterized model for the RSS. |
| SC | Security Camera |

System Structure

Embodiments herein disclose a Mobile Location System (MLS) for determining the locations of one or more movable objects within a site.

The system comprises one or more imaging devices (ImDs) such as security cameras (SCs) deployed in a site for capturing movable objects therein. The movable objects are also denoted as mobile agents (MAs) hereinafter.

The system also comprises one or more mobile wireless devices (MWDs). Each MWD is associated with a MA and movable therewith. Therefore in various embodiments, some MAs may each carry one MWD, some other MAs may each carry more than one MWD, and yet some other MAs may not carry any MWD.

The system comprises one or more reference wireless devices such as wireless access points (APs) deployed in the site. The APs are in wireless communication with the MWDs via one or more wireless signals. A server is functionally coupled to the ImDs, MWDs, and APs for calculating an estimate of the locations of the MAs and MWDs, and associating each MWD with a MA using available data and observations from the APs, MWDs, and ImDs. In various embodiments, the server may be one or more computing devices, and/or a distributed computing structure such as a cloud. As will be described in more detail later, the server may comprise a navigation engine or a location engine for calculating the location of the MAs.

A set of receiver signal strength (RSS) observables of the one or more wireless signals are measured either at the MA (by the MWD or a suitable device associated therewith) or at AP (measured by the AP or a suitable device associated therewith), and are sent to the server for facilitating the location determination of the MA.

The server calculates the locations of the MAs and MWDs, and computes estimates of the trajectories of the MAs and MWDs. The server also computes a probability of association (PoA) between the MWD and MA (that is, the likelihood of a MWD being associated with or attached to a MA). A PoA has a value between 0 (the MA and MWD are surely unassociated) and 1 (the MA and MWD are surely associated).

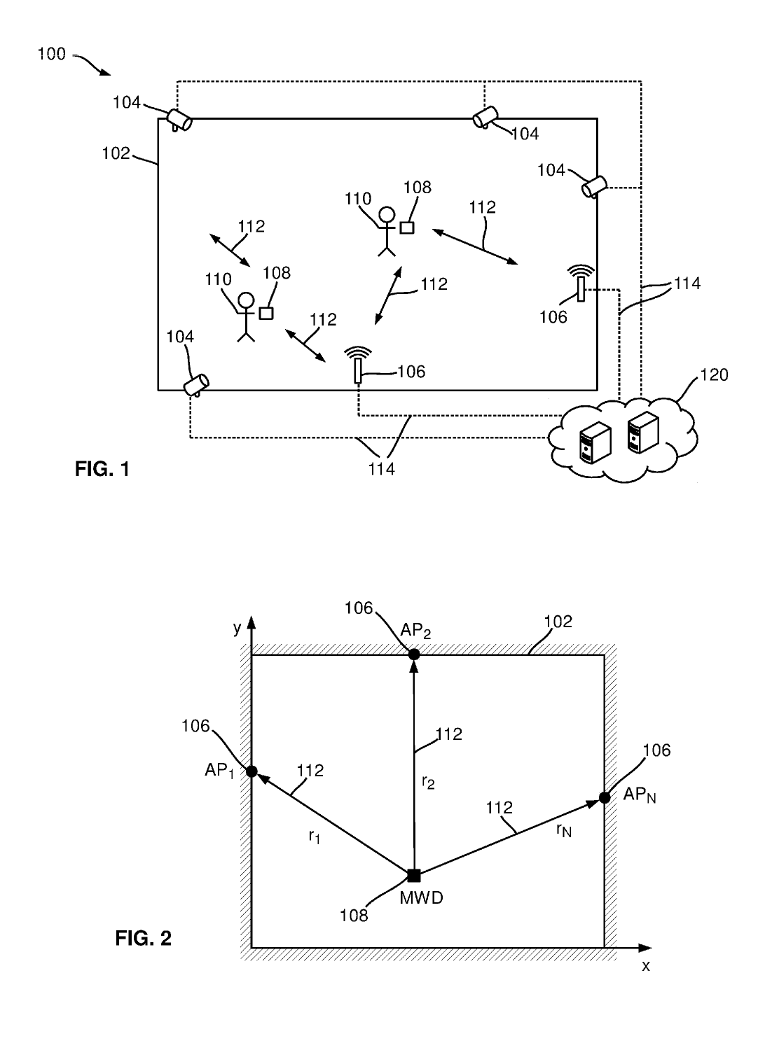

Turning now the FIG. 1, a Mobile Location System (MLS) system is shown, and is generally denoted using the reference numeral 100. The MLS system 100 tracks one or more MAs 110 movable in a site 102.

The MLS system 100 comprises M (M=1, 2, . . . ) ImDs 104 and N (N=1, 2, . . . ) reference wireless communication devices 106 deployed in a site 102 such as a building complex. The reference wireless communication devices 106 may be any suitable wireless communication devices such as APs, licensed band radio stations such as cellular base stations, and/or the like. The ImDs 104 and APs 106 are functionally coupled to a server 120 via suitable wired and/or wireless communication structures 114 such as Ethernet, serial cable, parallel cable, USB cable, HDMI® cable (HDMI is a registered trademark of HDMI Licensing LLC, San, Jose, Calif., USA), Wi-Fi® (Wi-Fi is a registered trademark of Wi-Fi Alliance, Austin, Tex., USA), Bluetooth® (Bluetooth is a registered trademark of Bluetooth Sig. Inc., Kirkland, Wash., USA), ZigBee® (ZigBee is a registered trademark of ZigBee Alliance Corp., San Ramon, Calif., USA), 3G or 4G wireless telecommunications, and/or the like. In these embodiments, the server 120 may comprise one or more computing devices, and/or a distributed computing structure such as a cloud.

In these embodiments, an ImD is a camera or scanner attached to a stationary structure at a fixed location and capable of imaging persons or other mobile objects. Such an ImD may be any suitable camera or scanner such as a generic camera, a security camera, a scanner, or the like. For example, in various embodiments, an ImD may be a wall-mounted camera or scanner within a building complex, or a camera or scanner mounted on a streetlamp, an exterior building wall, or any other suitable structure in an outdoor environment.

The MLS system 100 also comprises one or more MWDs 108, each associated with a MA 110 and movable therewith. Therefore, the location of a MWD 108 is generally the same as that of the MA 110 associated therewith. The MLS system 100 uses the ImDs 104 and APs 106 to track the MAs 110 and MWDs 108, and establish associations therebetween.

In these embodiments, a MA is generally a movable object such as a person, a robot, a cart, a wheelchair, a drone, or the like, which can move through a sufficiently large space such that the MA can be imaged, detected, and tracked by the ImDs 104.

A MWD 108 is generally a wireless device suitable for attaching to a MA 110. In various embodiments, a MWD 108 may be self-contained and powered by a battery or other suitable energy source, and may be physically small such that it cannot be reliably observed by an ImD. A MWD 108 may comprise a wireless signal scanner for detecting a wireless signal and measuring the RSS thereof, and/or a variety of position-sensing sensors such as an accelerometer, a rate gyro, a barometer, a magnetometer, one or more cameras, and/or the like, that may be used for determining the position of the MWD 108. Examples of a MWD 108 include a wireless beacon device, a two way Wi-Fi® data radio, a smartphone, a tablet, a laptop computer, a personal data assistant (PDA), or the like,

Each MWD 108 is in wireless communication with one or more APs 106 via one or more wireless signals 112. In various embodiments, the wireless signal 112 may be any wirelessly transmitted signal suitable for Receiver Signal Strength (RSS) measurement. Such a wireless signal 112 may be in accordance with any suitable wireless communication standard such as Wi-Fi®, Bluetooth®, ZigBee®, 3G or 4G wireless telecommunications or the like, and/or may be in any suitable form such as a generic wireless communication signal, a beacon or a broadcast signal. Moreover, such a wireless signal 112 may be in either a licensed or unlicensed band, and may be either a digital-modulated or an analog-modulated signal. In some embodiments, the wireless signal 112 may be an unmodulated carrier signals.

More specifically, the wireless signal 112 is a signal emanating from a wireless transmitter with an approximately constant time-averaged transmitting power known to a wireless receiver that measures the RSS thereof.

Furthermore, while a wireless signal is typically transmitted from a MWD or an AP within a site such as a building, it may also be a wireless signal transmitted from outside the site such as a cellular signal or a broadcast radio signal or a satellite signal.

In various embodiments, the RSS measurements or RSS observables may be obtained by a MWD 108 or by an AP 106. For example, in some embodiments, each MWD 108 may transmit a wireless signal to one or more APs 106. Each AP 106 receiving the transmitted wireless signal measures the RSS thereof, and sends the RSS observables to the server 120 for processing. In some other embodiments, each MWD 108 may receive wireless signals from one or more APs 106. The MWD 108 receiving the wireless signals measures the RSS thereof, and sends the RSS observables to the server 120 for processing. In yet some other embodiments, some MWDs 108 may transmit wireless signals to one or more APs 106, and some APs 106 may transmit wireless signals to one or more MWDs 108. In these embodiments, the receiving devices, being the APs 106 and MWDs 108 receiving the wireless signals, measure the RSS thereof, and send the RSS observables to the server 120 for processing.

In some embodiments, the MWDs 108 also send data collected by the position-sensing sensors to the sever 120.

In various embodiments, a MWD 108 may send RSS observables and/or position-sensing sensor observables to the server 120 in any suitable ways. For example, in some embodiments, a MWD 108 may send position-sensing sensor data directly to the server 120. In some alternative embodiments, a MWD 108 may send position-sensing sensor data to one or more receiving devices such as one or more APs 106 and/or other suitable receiving devices, and the one or more receiving devices forward the received data to the server 120.

The MLS system 100 shown in FIG. 1 uses ImDs 104 and Computer Vision (CV) processing to track MAs 110, and uses MWD observables such as RSS observables and/or position-sensing sensor observables, to track the MWDs 108. The MLS system 100 then establishes the associations between the MAs 110 and MWDs 108.

Each ImD 104 captures a sequence of images. The captured images may be in any suitable format such as the uncompressed raw format or any suitable compressed format such as jpeg, gif, tiff, and the like.

The captured images are processed using a suitable CV process, and the processed images or image sequences are then stored in the server 120. Those skilled in the art will appreciate that, in various embodiments, the CV processing may be conducted in the ImDs 104, in the server 120, or in both the ImDs 104 and the server 120. For example, the captured image sequences may be processed in the ImDs 104 and the processed image sequences are then sent to the server 120. In another example, the captured image sequences are sent from the ImDs 104 to the server 120, and the server 120 processes the received image sequences using a CV process. In yet another example, the captured image sequences may be partially-processed or pre-processed in the ImDs 104 by a preliminary CV process, and the pre-processed image sequences are sent to the server 120 for further CV processing. In still another embodiment, the server 120 is located remote to the site 102. The image sequences captured by the ImDs 104 are sent to a local computing device (not shown) in or near the site 102 for CV processing and then, the processed image sequences are sent to the server 120.

The server 120 detects one or more MAs 110 from the processed image sequences. In some embodiments, the MAs 110 are detected as binary large objects (blobs) in the images. The positions of the detected MAs 110 are mapped from the image plane (such as the x-y coordinates of the detected MAs 110 in an x-y coordinate system of the images) to the physical site using a suitable projective transformation. In some embodiments, the mapped position of a MA 110 in the physical site may be a two-dimensional (2D) position (such as its x-y coordinates). In some embodiments, the mapped position of a MA 110 in the physical site may be a three-dimensional (3D) position (such as its x-y-z coordinates). Thus, MAs 110 are detected from the image sequences, and are tracked by the CV processing. However, the CV processing may not be able to provide identification for the detected MAs.

The position-sensing sensor observables obtained from the position-sensing sensors of the MWD 108, and/or the RSS observables of the wireless signal 112 are sent to the server 120. The locations of MWDs 108 are detected and tracked based on RSS observables and/or position-sensing sensor observables.

For example, in some embodiments, all MWDs 108 transmit wireless signals 112 at a same transmitting power level. Then, an AP 106 receiving a wireless signal 112 transmitted from a MWD 108, can measure the RSS of the received wireless signal 112 and use a propagation model to estimate the distance between the AP 106 and the MWD 108. In some alternative embodiments, the MWDs 108 transmit wireless signals 112 at different transmitting power levels which may be predefined and known to the APs 106, or the values thereof may be otherwise embedded in the transmitted wireless signals such that the APs 106 receiving the wireless signals 112 can retrieve the transmitting power levels. When an AP 106 receives a wireless signal transmitted from a MWD 108, the AP 106 can use the transmit power level of the wireless signal, the RSS thereof, and the propagation model to estimate the distance between the AP 106 and the MWD 108.

The server 120 then calculates and tracks the correlation of the MAs 110 and MWDs 108 to determine if a MA 110 and a MWD 108 are substantively at the same location, which may imply that the MA 110 and the MWD 108 may be associated and movable together. A probability of association (PoA) between the MA 110 and the MWD 108 is calculated. The association of the MA 110 and the MWD 108 is established when the MA 110 is positively identified and the PoA of the MA 110 and the MWD 108 is sufficiently large such as larger than a predefined probability threshold. In some embodiments, the predefined probability threshold is a value close to one (1).

In some embodiments, MAs 110 and MWDs 108 are tracked to obtain their respective trajectories (i.e., the paths that the MAs 110 and the MWDs 108 have been moved therethrough) for establishing the associations therebetween and the corresponding PoAs.

One or more receiver signal strength models (RSSMs) of the one or more wireless signals may be used for tracking the mobile objects. In some embodiments, the RSSMs are generated via an initial calibration process, and are updated via a maintenance calibration process when a crowd-sourcing opportunity event occurs during mobile object tracking.

Herein, a crowd-sourcing opportunity event refers to an event that may be used for generating and/or updating a RSSM, or an event that may be used for locating a MA 110. For example, a crowd-sourcing opportunity event may be an event wherein a MA 110 and a MWD 108 are associated with each other, i.e., the PoA thereof is sufficiently large. Data obtained in a crowd-sourcing opportunity event, such as the location of the MA 110, the RSS measurement or observables, position-sensing sensor observables, and the like, may be denoted as crowd-sourced data.

RSS Model

In some embodiments, the MLS system 100 uses one or more RSS models (RSSMs) of the site 102 for facilitating mobile object tracking. Each RSSM corresponds to a wireless signal 112, and approximates the RSS of the corresponding wireless signal 112 that a receiver in the site would observe. The MLS system 100 builds and calibrates the RSSMs during one or more surveying or calibration stages or modes (described later).

In tracking a MWD 108, the server 120 compares the RSS observables of the MWD 108 with the RSSM of the site 102 to estimate the location of the MWD 108.

In various embodiments, the system 100 may use any one or a combination of two types of RSSMs including a parametric RSSM and a non-parametric RSSM. When using the non-parametric model, a radio map may be generated comprising a plurality of RSS reference values at different locations of the site 102.

In the following, location estimation using the parametric model is first described. Then, location estimation based on the non-parametric model is described.

Parametric RSSM

FIG. 2 shows an example of a site 102. In this example, the site 102 is a building with a rectangular floor space and comprises N APs 106 and M ImDs (not shown) positioned at various locations thereof.

A MWD 108 at a location (xₘ,yₘ) transmits a beacon signal 112 which is received by the APs 106. Each AP 106 measures the RSS level of the received beacon signal 112, and records the measured RSS level of the received beacon signal 112. The N measured RSS levels form a vector of RSS observables:

r=[r₁r₂ . . . r_{N}], (1)

where rₙ (n=1, . . . , N) is the measured RSS level of the beacon signal 112 obtained by the n-th AP 108. The server 120 then uses r to estimate the location of the MWD 108.

In this example, the RSSM is represented by a parametric RSSM. Let the n-th AP 106 (denoted as APₙ) be located at (x_{ap,n}, y_{ap,n}), where n=1, . . . , N. Then, the range Rₙ between the MWD 108 and the Aₙ 106 is:

Rₙ=\sqrt{(X_{ap,n}−xₘ)²+(y_{ap,n}−yₘ)²}. (2)

A parametric model r_{P,n} for the RSS of the n-th AP 106 and the MWD 108 is given as:

r_{P,n}=c_{1,n}+c_{2,n}g(Rₙ), (3)

where {c_{1,n}, c_{2,n}} are parameters pertaining to the wireless link between the MWD 108 and the n-th AP 106, and are typically determined by a suitable calibration process. g(•) is an arbitrary function of the argument which is generally nonlinear, and is known as part of the configuration of the RSSM. As {c_{1,n}, c_{2,n}} have been determined by the calibration process, the estimated current location (\hat{x}ₘ,ŷₘ) of the MWD 108 can be computed based on an algorithm function ƒ(•) as

(\hat{x}ₘ,ŷₘ)←ƒ(r,x_{ap,1}, . . . ,X_{ap,N},y_{ap,1}, . . . ,y_{ap,N},c_{1,1}, . . . ,c_{1,N},c_{2,1}, . . . ,c_{2,N}). (4)

Here the “hat” or circumflex symbol (“̂”) denotes estimate. For example, \hat{x}ₘ is the estimate of the xₘ coordinate of the MWD 108. The function ƒ(•) is a processing algorithm that is typically referred to as the “location engine” or “navigation engine” in the literature.

The positions of APs 106 may be recorded in a general building map (BM) or more generally, a site map. The BM is a general container of all details of the static components of the interior of the building such as floor plan, wall locations, locations of ImDs 104 and APs 106.

In above parametric model, two coefficients may be considered for each MWD-AP link (i.e., the wireless signal 112), which may be extended to a model of arbitrary complexity. Hence, we denote cₙ as a vector of coefficients of arbitrary length for the MWD to APₙ link. Also, the parametric RSSM of r_{P,n} is typically linear in terms of the coefficients in cₙ as this facilitates calibration. However, the method disclosed herein can work with either linear or nonlinear functions of cₙ.

Values of cₙ have to be determined before the location engine can be used to estimate the MWD location. Generally, cₙ is determined by measuring the RSS at a number of known reference points or locations throughout the site 102. With the set of RSS observables at the reference points, a suitable curve-fitting process is used to numerically determine the values of cₙ. For example, any known curve-fitting method based on least squares may be used herein.

Nonparametric RSSM

The nonparametric RSSM is based on establishing a so-called radio map. In the literature, the use of radio maps for location determination is typically referred to as “fingerprinting” as the vector r is a “fingerprint” or pattern of values for comparing with the radio map data. In machine learning area, the concept can be further generalized as Support Vector Machines. In some embodiments, the system may use a more sophisticated RSSM which is a combination of a parametric RSSM and a non-parametric RSSM.

In the embodiment described below, a radio map is generated for each AP 106, and therefore, for a system (see FIG. 1) having N APs 106, N radio maps are generated. However, those skilled in the art will appreciate that, in some alternative embodiments where some or all APs 106 each transmit a plurality of wireless signals for connecting to MWDs 108, a radio map may be generated for each wireless signal.

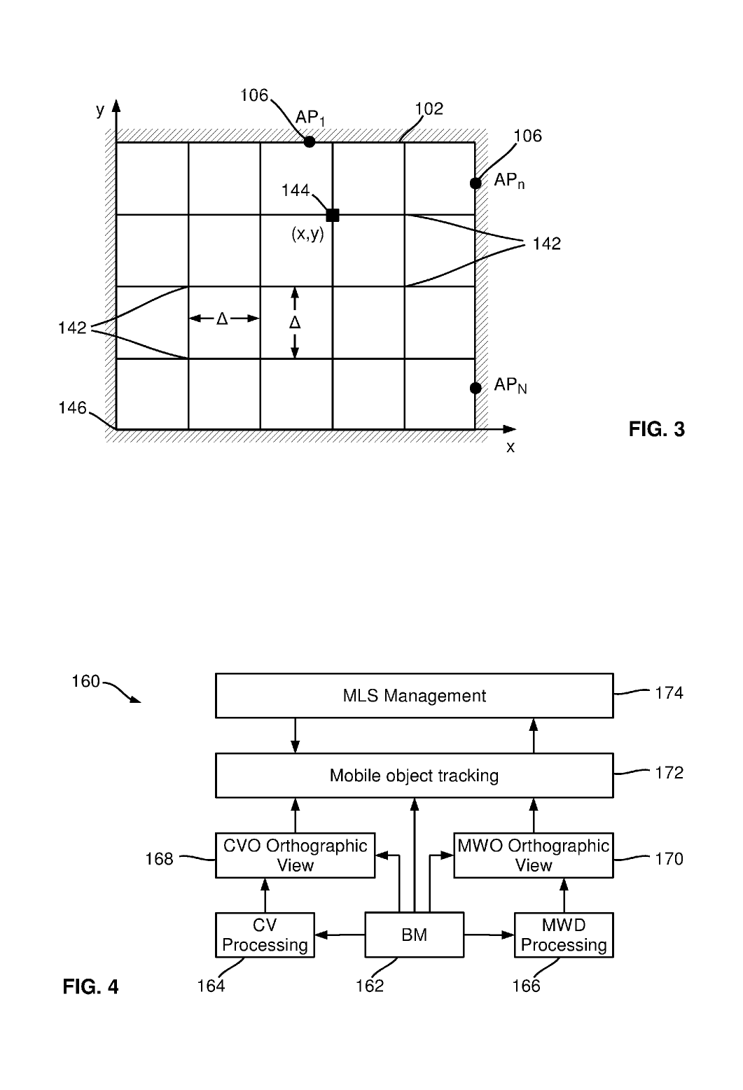

Referring to FIG. 3, to build a radio map, the floor space of the site 102 is partitioned into a 2D grid system having a matrix of 2D grid points 142 with a constant grid spacing Δ. Of course, in some alternative embodiments, the grid points 142 may have different spacings.

The coordinates of each grid point is (x_{i,j}, y_{i,j}) where i is the grid index along the x direction and j is the grid index along the y direction. Then, a radio map for a reference device APₙ, denoted as RMₙ, comprises the RSS values for the grid points 142, each corresponding to the RSS level of a reference wireless signal transmitted at a known reference-transmitting-power level from a device at the grid point (x_{i,j},y_{i,j}) and received by the APₙ. Thus, RMₙ is a matrix having the same dimensions of the floor grids with elements RMₙ(i,j) each corresponding to a reference RSS value for the grid point (x_{i,j},y_{i,j}).

The established radio maps are used for tracking the MWDs 108. Those skilled in the art will appreciate that, in embodiments where the wireless signals between the MWDs 108 and APs 106 are transmitted at transmitting powers different from the reference-transmitting-power, the RSS values are normalized to correspond to those of wireless signals transmitted at the reference-transmitting-power.

When tracking a MWD 108, the RSS values of the wireless signals transmitted between the MWD 108 and one or more APs 106 are determined and normalized if needed. Then, the vector r is built as described above, and is compared with the radio maps of the one or more APs 106 to calculate a maximum likelihood location for the MWD 108. Although each radio map only comprises a limited number of grid points 142, the calculated maximum likelihood location of a MWD 108 is not restricted to the grid points 142, and may be any location in the site 102.

Software Structure

FIG. 4 is a schematic diagram showing a software structure 160 of the MLS system 100. As shown, the software structure 160 comprises a BM container 162 which is a container of information regarding the building details, the floor-plan wall location, location of each ImD 104, location of each AP 106, and the like. The BM container 162 also stores the obtained radio maps and calibration details for the ImDs 104.

The BM container 162 provides necessary information to all processing blocks 164 to 174 as they may need. Therefore, the system 100 uses the information in the BM container 162 for facilitating CV processing, CV object (CVO) detection and tracking (described later), MWD data processing, mobile wireless object (MWO) detection and tracking (described later), and MA tracking.

The software structure 160 comprises a CV processing block 164 and a CVO orthographic view (CVOOV) block 168.

The CV processing block 164 comprises all CV processing functions for processing image sequences captured by the ImDs 104. The CV processing block 164 detects and tracks the blobs in the ImD-captured images that may potentially be identified as MAs 110. The output of the CV processing block 164 may be the foreground blob regions of detected MAs 110 and/or the trajectories of the MAs 110 on the BM. Based on the blob regions detected in each image, image features such as the color histogram within the blob region, the size of the blob region, and/or the like, may be calculated and used as the attributes of the blob. A blob can be of various types and may correspond to more than one MA 110. For example, two or three MAs 100 that partially occlude each other may appear in captured images as one blob.

Each blob and its attributes represent a CVO which may represent one or more MAs 110. For example, a small cluster of MAs 110 may exhibit in the ImD-captured images as a single CVO which may be later split to multiple CVOs when the MAs 110 move away from each other.

The CVOs are tracked in the CVOOV block 168 in an orthographic or birds-eye view of the floor space using a Bayesian model to obtain a Bayesian estimate of the trajectory of each MA 110. As described above, the floor space is partitioned into a 2D matrix of grid points (see FIG. 3) in embodiments that nonparametric RSSM is used. The obtained Bayesian estimate of the trajectory of each MA 110 is sent to a mobile object tracking block 172. A model of the physical motion of the MAs 110 is used in estimating the trajectory of each MA 110.

The software structure 160 also comprises a MWD processing block 166 and a MWO orthographic view (MWOOV) block 170. In the MWD processing block 166, RSS observables and position-sensing sensor observables are collected from MWDs 108 and combined into a MWO. In these embodiments, each MWD 108 is uniquely identifiable such as based on the Medium Access Control (MAC) address thereof (which may be stored in the server 120 or sent from the MWD 108 to the server 120). Therefore, the MWOs and active MWDs 108 in the site 102 can be one-to-one mapped with each other.

Each MWO is tracked in the MWOOV block 170 in an orthographic or birds-eye view of the floor space. The floor space is partitioned into a two dimensional matrix of grid points (see FIG. 3) in embodiments wherein nonparametric RSSM is used.

In the MWOOV block 170, the MWOs are tracked within the floor space based on Bayesian processing to obtain a Bayesian estimate of the trajectory of each MWD 108, which is sent to the mobile object tracking block 172 for tracking the MAs 110.

In particular, the BM 162 comprises the RSSM with the parameters and coefficients for each AP 106. The MWOOV block 170 may use the RSSMs with the current RSS observables and position-sensing sensor observables obtained from the MWD 108 to generate an estimate of the MWD trajectory. The model of the physical motion of the MAs 110 is used in estimating the trajectory of each MWD 108 as each MWD 108 is associated and movable with a MA 110.

As described above, the trajectories of MAs 110 and MWDs 108 obtained in the CVOOV block 168 and the MWOOV block 170 are sent to the mobile object tracking block 172. Under the management of a MLS management block 174, the mobile object tracking block 172 pairs the trajectories of MAs 110 and MWDs 108 (or more precisely the trajectories of CVOs and MWOs) and calculates the PoA between each pair of MA 110 and MWD 108 for determining the confidence of pairing. In these embodiments, the PoA is a matrix of probabilities that varies with time to reflect the changes in the MA and MWD tracking in the CVOOV and MWOOV blocks 168 and 170.

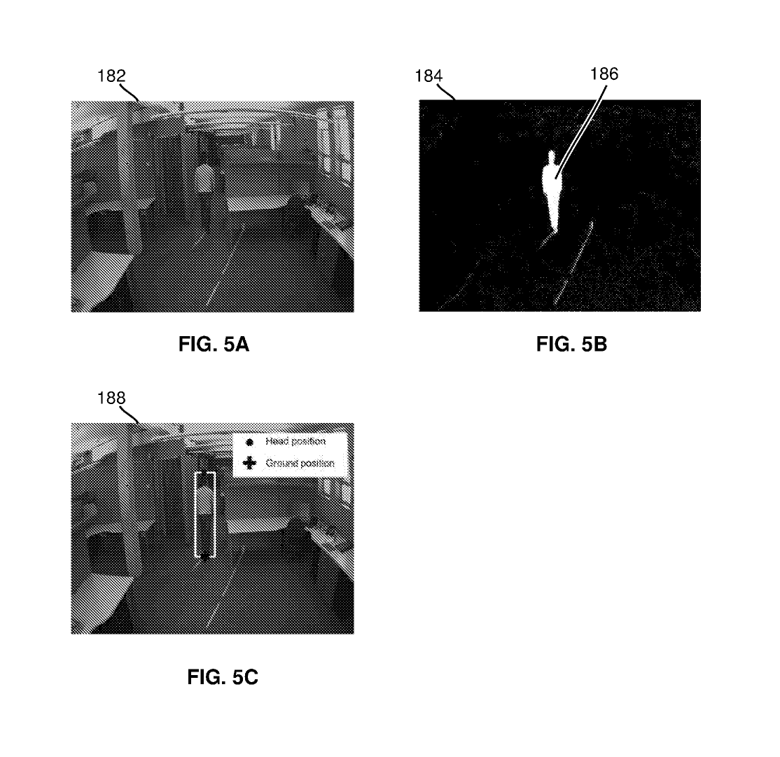

FIGS. 5A to 5C show an example of CV processing conducted in the CV processing block 164. The CV processing block 164 stores a background image for each ImD 104 (obtained at an initialization stage). As shown in FIG. 5A, a source image 182 is captured by an ImD 104. Then, the CV processing block 164 combines the source image 182 with the corresponding background image (not shown) to obtain a foreground mask image 184 (see FIG. 5B) by filtering the foreground (MA) from the background. As shown in FIG. 5B, a blob 186 is detected in the foreground mask image 184, which is then used as a CVO and is possibly corresponding to a MA 110. As shown in FIG. 5C, a bounding box 188 is produced by the CV processing block 164 for marking the detected CVO 186 and for estimating the location of the MA 110 in the 2D image plane. The estimated location of the MA 110 in the image plane is then projected onto the real-world coordinate system of the 3D space of the site 102 by using a suitable projective geometry processing method. For example, the location of a MA 110 in the image can be estimated as the floor contact point of the corresponding CVO in the 2D image plane, which is projected to a position (\hat{x}ₘ,ŷₘ) in the real-world coordinate system. Other attributes of the CVO such as the color histogram and the height of the target may also be used in the mobile object tracking block 172 for PoA calculation.

The accuracy of the estimated locations (\hat{x}ₘ,ŷₘ) of a MA 110 is degraded when the MA 110 is at a distance from the ImD 104. To solve this issue, a main field of view (FOV) area with one or more entrance/exit areas may be defined and associated with each ImD 104. Such a main FOV area corresponds to at least a portion of the FOV of the ImD 104 that the estimated locations (\hat{x}ₘ,ŷₘ) of a MA 110 has sufficient accuracy. The area between the main FOV areas of two neighboring ImDs 104 may be defined as an estimation area or blind area.

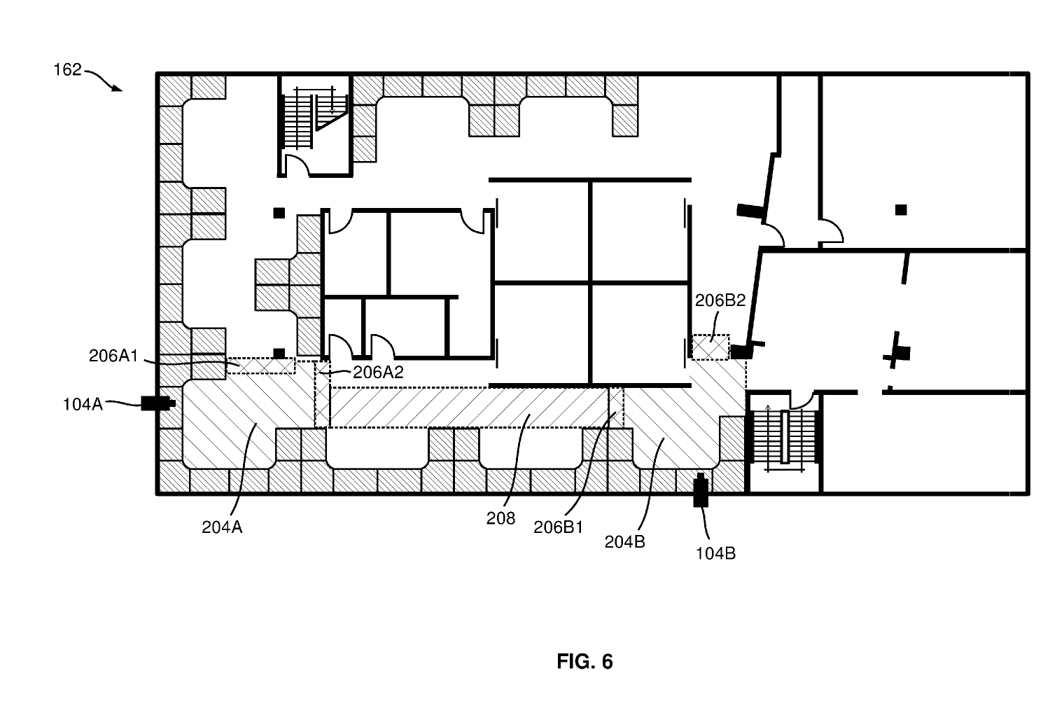

FIG. 6 shows an example of a BM 162 of a site 102. In this example, two neighboring ImDs 104A and 104B with non-overlapped main FOV areas are shown. The ImD 104A is associated with a main FOV area 204A with entrance/exit areas 206A1 and 206A2. The ImD 104B is associated with a main FOV area 204B with entrance/exit areas 206B1 and 206B2. The area between the two main FOV areas 204A and 204B is set as an estimation area 208.

When a MA 110 is moving from one ImD 104 to a neighboring ImD, the position state (in a main FOV area or in an estimation area) of the MA 110 may be obtained from the CV processing by checking whether the MA 110 is entering or leaving a main FOV area of an ImD 104 through a corresponding entrance/exit area.

If it is determined that a MA 110 is within the main FOV area of an ImD 104, the position of the MA 110 in the real-world coordinate system is then determined by projective geometry mapping from its location in the image plane. If it is determined that a MA 110 is within an estimation area between two neighboring ImDs 104, the position of the MA 110 in the real-world coordinate system is then determined by interpolation based on the previous locations of the MA 110.

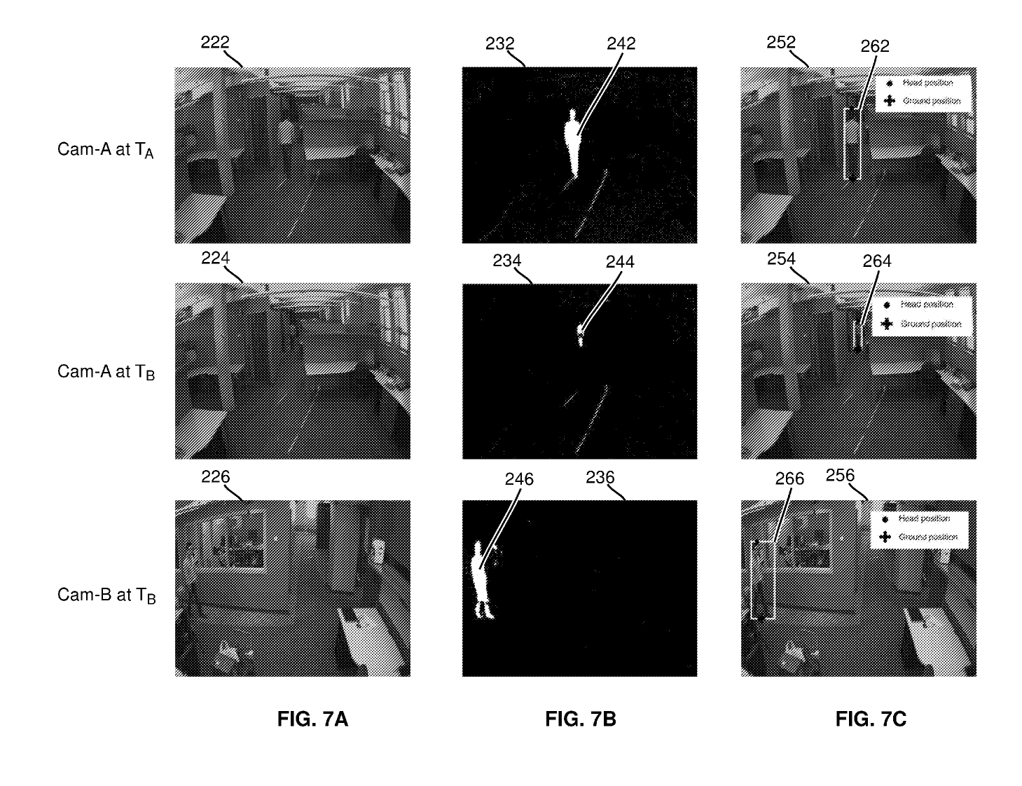

FIG. 7A shows three source images 222, 224, 226 captured by the two neighboring ImDs 104A and 104B (denoted as Cam-A and Cam-B) in FIG. 6 at different time instants. In particular, image 222 is captured by Cam-A/104A at a time instant TA, images 224 and 226 are captured by Cam-A/104A and Cam-B/104B, respectively, at a later time instant TB.

FIG. 7B show the foreground mask images 232, 234, 236 obtained from source images 222, 224, 226, respectively. Each foreground mask image 232, 234, 236 comprises a detected CVO 242, 244, 246, respectively. FIG. 7C show the images 252, 254, 256 with the bounding boxes 262, 264, 266 added to the detected CVOs 242, 244, 246.

By using the BM 162 and the model of the physical motion of the MAs 110 in the site 102, the system 100 determines that the CVOs 242, 244, 246 correspond to a same MA 110. Moreover, the system 100 determines that the MA 110 has moved out of the main FOV area 204A of the ImD Cam-A/104A via the entrance/exit area 206A2, and the projected location of the MA 110 based on the image 222 captured by the ImD Cam-A/104A is unreliable. On the other hand, the system 100 also determines that the MA 110 has entered the main FOV area 204B of the ImD Cam-B/104B via the entrance/exit area 206B1. Therefore, the projected location of the MA 110 based on the image 226 captured by the ImD Cam-B/104B is used as the location of the MA 110.

As described above, if a MA 110 is in an estimation area, interpolation is used for determining the position of the MA 110. In some embodiments, constraints such as the boundaries of the estimation area may be used to limit the moving range of a MA 110. For example, a constraint in some embodiments may be that the MA 110 cannot go outside of the estimation area 208 of the BM 162. Then, the locations of the MA 110 inside the estimation area 208 may be interpolated based on previously estimated locations calculated from the CV processing 164.

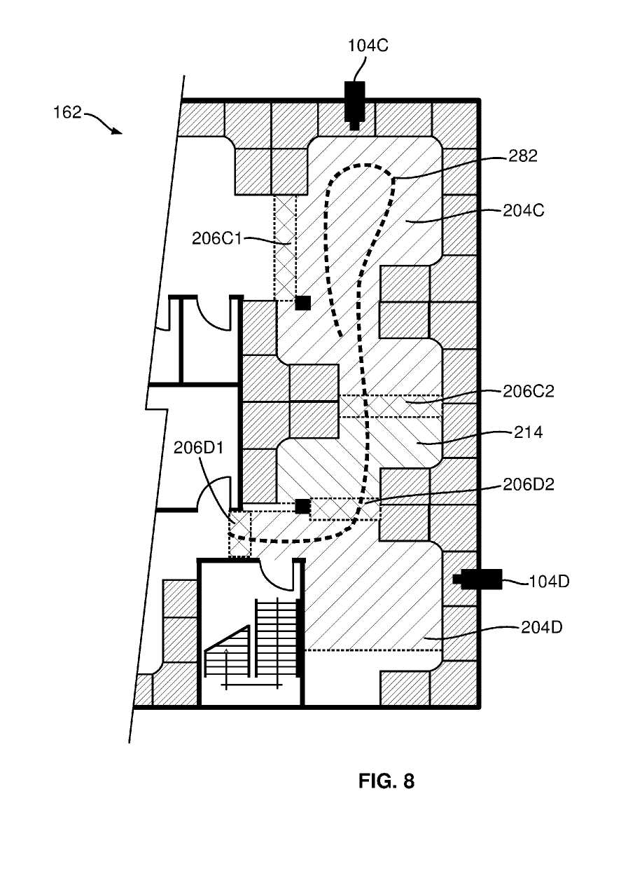

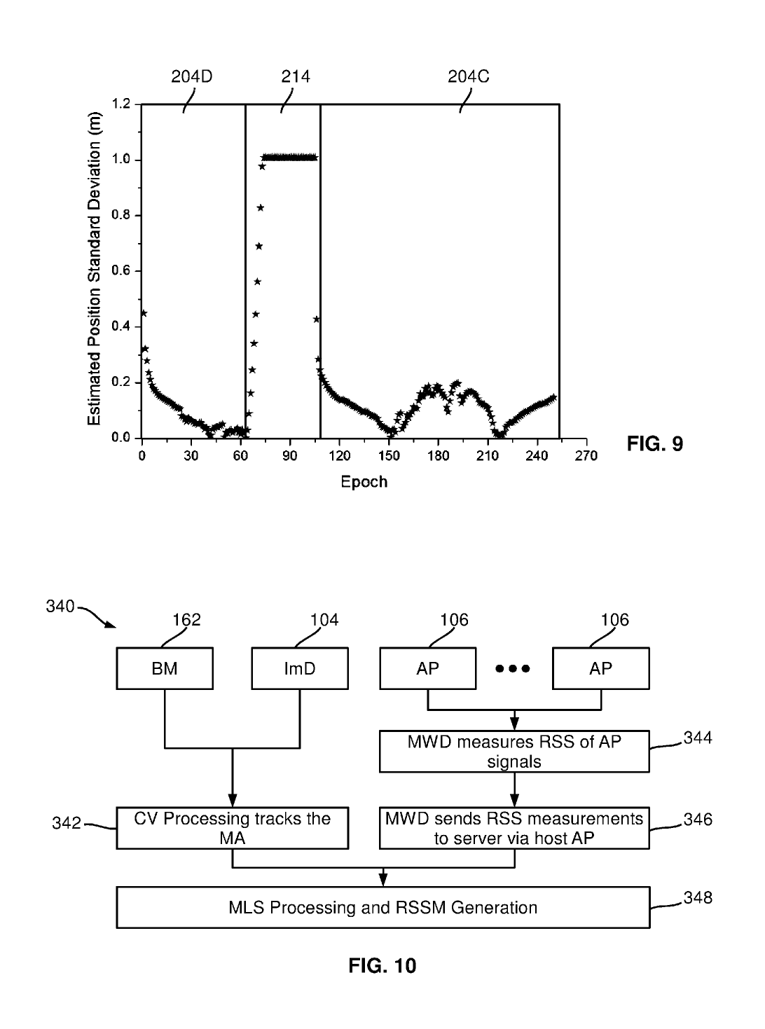

FIG. 8 shows an example of tracking a MA (not shown) walking along a path 282 in the site. Two ImDs 104C and 104D with non-overlapped main FOV areas are used for tracking the MA. The ImD 104C has a main FOV area 204C with two entrance/exit areas 206C1 and 206C2. The ImD 104D has a main FOV area 204D with two entrance/exit areas 206D1 and 206D2. An estimation area 214 is defined between the two main FOV areas 204C and 204D. The error variance distribution in the form of standard deviation of the estimated locations of the path 282 is shown in FIG. 9. As can be seen, the standard deviation of the estimated locations of the path 282 in the main FOV areas 204C and 204D is small, and that in the estimation area 214 is relatively large.

The processing of the CVOOV and MWOOV (blocks 168 and 170 of FIG. 4) each comprises a two-step Bayesian processing for updating the CVOs and MWOs (described below) and results in a posteriori probability of the state variables associated with the tracked objects conditioned on all observations accumulated to the present time.

For ease of description, the following description only considers the displacement state variables, which are the two floor space displacement variables x and y on the floor grid. Referring again to FIG. 3, the displacement variables x and y of a MA/MWD 144 are the distances between the MA/MWD 144 and a predefined reference point 146 along an x-axis and a y-axis, respectively. In embodiments that the predefined reference point 146 is the origin of an x-y coordinate system, the displacement variables x and y of the MA/MWD 144 are the x and y coordinates thereof.

In the CVOOV and the MWOOV orthographic grid observation blocks 168 and 170, at the completion of an update cycle (processing of CV or MWD data) a Minimum Mean Square Error (MMSE) estimate of the state variables is calculated as the mean of the updated a posteriori distribution. Consequently, the two-step Bayesian processing for updating a CVO or MWO (collectively denoted as a tracking object) comprises the following two steps:

1. Probability Diffusion

The dynamic motion of a tracking object (for example a CVO or MWO) is determined by a plurality of parameters of the tracking object, and may be described as a function of the state variables estimated from the previous update cycle. A diffusion probability kernel is created from the state variables and convolved with the a posteriori probability of the output of the previous update cycle. Let sₜ represent the state variable vector where the subscript t denotes the update time index. Let p(sₜ₋₁) represent the a posteriori probability of the state variable vector sₜ conditioned on the complete set of observations up to the time t−1. Furthermore, define p(sₜ|sₜ₋₁,uₖ) as the kernel of the diffusion probability that is tantamount to the transition probability between the states of sₜ₋₁ and sₜ conditioned on any deterministic update component uₖ. The predicted state probability for update t, denoted as p̅(sₜ), is then given as the general vector convolution as

p̅(sₜ)=∫p(sₜ|sₜ₋₁,uₖ)p(sₜ₋₁)dsₜ₋₁. (5)

It is noted that p(sₜ|sₜ₋₁,uₖ) is specifically dependent on the BM and forbids transition probability through object-impenetrable walls or into forbidden areas where it is impossible for the object to be located.

2. Correction with Measurements

During the update time interval of t−1 to t, there is a set of observation events that are then accounted for. In the CV case, this may be a CVO output from one or more of the ImDs 104. If a MA 110 enters the estimation area, the CV update may be replaced by an interpolation method such as described above. Likewise there may be an RSS or position-sensing sensor observation for a MWD 108. The set of available CV or MWD sensor (including RSS and/or position-sensing sensors) observations is denoted as zₜ. The likelihood of zₜ based on the state vector sₜ is determined individually for the CV and the MWD and is denoted in general as the conditional probability of (zₜ|sₜ). This is applied as the second Bayesian update step or state a posteriori probability correction step as

p(sₜ|z)=ηp(zₜ|sₜ)p̅(sₜ), (6)

where η is a normalizing constant such that p(sₜ|z) integrates to unity.

In these embodiments, the state variables only comprise the 2D grid of the floor space, thereby resulting in a 2D RSSM. Those skilled in the art will appreciate that in other embodiments other state variables may be used. For example, in various alternative embodiments, other variables relevant to the RSSM such as the height z of a MWD with respect to a reference surface such as the floor, MWD type, MWD orientation, the MWD position on the MA, the velocity and moving direction of a MA/MWD, and/or the like, may also be used as state variables, thereby resulting in a multi-dimensional RSSM. It is noted that in some embodiments wherein the system has limited computational capability, it may be impractical to have the RSSM accommodate all of these variables.

In the embodiments that uses the height z of MWD as a state variable, the height z may be a discrete variable quantized in terms of building floors as this is usually easily detectable with barometers or prior trajectory history.

MWD orientation is generally difficult to determine and varies significantly with time. For example if the MWD 108 is a small tag device and a MA 110 carries the MWD 108 in a pocket, then the MWD orientation is essentially a random process as the MA 110 walks. In this case the orientation of the MWD 108 is best represented as a random variable. For example, suppose that the RSSM has been created and calibrated based on MWD orientation as a variable. When reading out this RSSM for the MWD 108, the orientation thereof is assumed to be random and hence the RSSM is averaged with respect to this state variable. Given a crowd-sourcing opportunity event triggered by the MA 110 carrying such MWD 108, the collected RSS data can be rejected as it originates from a MWD of random orientation. However, a calibration processing can be implemented such that the inference of the MWD RSS data is accounted for although the orientation of the MWD is random. There are many known algorithms that can quantify this inference, and hence the RSSM parameters and coefficients can still be updated based on such incomplete data. In general, any RSS data from an arbitrary MWD 108 that has triggered a crowd-sourcing opportunity with unknown or random state variables can still contribute to a RSSM maintenance calibration (described later) by using statistical inference algorithms.

Many suitable algorithms may be used for establishing the pairwise PoA between the MAs 110 and MWDs 108. These algorithms are generally complex. The choice of algorithm depends on the details of the scenario. In general, for the MLS described in these embodiments, the CVOOV and MWOOV may result in grid-based approximations of the a posteriori probability density functions. These functions evolve with time as the trajectories of the MA 110 and MWD 108 change. To make the grid-based approximations tractable, similarity evaluations may be employed to estimate the similarities between the a posteriori distributions (such as the a posteriori probability density functions) of the MA 110 and MWD 108. In these embodiments, the Kullback Leibler Distance (KLD) is used for similarity estimation. In particular, pairwise KLDs are computed and compared to thresholds. Then, a quantitative comparison of the MA 110 and MWD 108 is made and the PoA is derived therefrom.

Those skilled in the art will appreciate that other algorithms such as Bhattacharyya Distance may alternatively be used for similarity estimation.

RSS Calibration

RSS calibration may be required for using the RSSM. A practical issue with a RSSM is that it typically becomes less accurate over time due to environmental changes in the site 102 such as APs being modified or moved, facilities in the building space being changed, and/or the like. For example, the floor covering may be replaced with a material that has different electromagnetic properties thereby resulting in changes to the wireless propagation such that the RSSM (for example, values of cₙ in embodiments where the parametric RSSM is used) is changed and has to be re-evaluated. Consequently, RSS calibration may be repeatedly conducted.

In embodiments herein, two modes of RSSM calibration are described, including an initial calibration mode executed by the system 100 at an initialization stage for generating the initial RSSM (for example, values of cₙ in embodiments where the parametric RSSM is used), and a maintenance calibration mode periodically executed by the system 100 during tacking MAs 110 and MWDs 108 for updating the RSSM based on changes in the building wireless propagation.

In these embodiments, ImDs 104 in the site 102 are used for RSSM calibration in both the initial and maintenance calibration modes. The ImDs 104 are initially calibrated such that objects in the captured images can be mapped to a corresponding location in the building space or the site 102. In other words, an object such as a MA 110 in the FOV of an ImD 104 can be mapped to a corresponding point or location on the building floor based on a suitable projective transformation.

In the maintenance calibration mode, a maintenance calibration event (also denoted as a calibration event hereinafter) refers to an event that a maintenance calibration of the RSSM is conducted. In some embodiments, a maintenance calibration event may be triggered by a crowd-sourcing opportunity event in which a MA 110 is paired or associated with an MWD 108 with a sufficiently high PoA. In some other embodiments, a maintenance calibration event may be triggered by a crowd-sourcing opportunity event and one or more other conditions (described later). Generally, the maintenance calibration events occur during tracking of MAs 110, and many crowd-sourcing opportunity events during MA tracking may qualify for triggering maintenance calibration. Therefore, in some embodiments, maintenance calibration may be periodically conducted in response to the qualified crowd-sourcing opportunity events occurring at or about predetermined or scheduled time instants.

Initial RSSM Calibration Mode

In the initial RSSM calibration mode, a MA 110 carrying a MWD 108 traverses the floor space of the site 102. As there is only a single MA 110 and a single MWD 108 roaming in the floor space, the PoA between the single CVO and the single MWD is one. In other words, the MA 100 detected in the captured images is always surely paired with the MWD 108. Moreover, as no RSSM has been established in the initial calibration mode, the projected location determined by the CVOOV 168 is used as the location of the MA 110 for tracking the trajectory of the paired MA 110 and MWD 108.

FIG. 10 is a flowchart showing the steps of a process 340 of the initial calibration mode. As shown, the single MA 110 is detected and tracked via the ImDs 104 and CV processing 164 based on the BM data 162 (step 342). The wireless signals transmitted from APs 106 are detected by the wireless signal scanner of the MWD 108, and the RSS thereof is measured (step 344). The RSS measurements are sent via the host AP to the server 120 (step 346), in which the mobile object tracking block 172 combines the CVO and MWO data and generates the RSSM (step 348).

In embodiments using a parametric RSSM, the mobile object tracking block 172 calculates RSSM parameters and coefficients at step 348 for generating the parametric RSSM. In embodiments that use a nonparametric RSSM, the mobile object tracking block 172 updates the radio maps at step 348 for generating the nonparametric RSSM.

Initial Calibration of the Parametric RSSM

With the MA 110 carrying the MWD 108 and traversing the floor space of the site 102, the vector of RSS observables r=[r₁ r₂ . . . r_{N}] (see Equation (1)) is continuously measured by the MWD 108, and the MA 110 is detected and tracked by the ImDs 104 and the CV processing. As described above, the MA 110 is detected in the images captured by one or more ImDs 104 and is mapped to a location (xₘ,yₘ) in the floor space of the site 102. Thus, during the initial RSSM calibration, a plurality of reference points are established and are associated with the RSS observable vector r measured at the corresponding locations. The RSS parameters of cₙ are then evaluated based on the reference points and the corresponding RSS observable vector r using a suitable numerical curve-fitting method.

In some alternative embodiments, the MA 110 may carry the MWD 108 and traverse the floor space of the site 102 for multiple times to obtain a plurality of RSS observable vectors r at each reference point. The obtained RSS observable vectors at each reference point are then combined, such as averaged, to obtain a combined RSS observable vector at each reference point. The RSS parameters of cₙ are then evaluated based on the reference points and the corresponding combined RSS observable vector r by using for example, a suitable numerical curve-fitting method.

Initial Calibration of the Nonparametric RSSM

As described above, the nonparametric RSSM is based on establishing one or more radio maps. Creating and maintaining radio maps are expensive in terms of surveying. In the following, a method for initial calibration mode of a nonparametric RSSM is described for efficiently creating and maintaining radio maps. The method may also be used for maintenance calibration of a nonparametric RSSM.

Similar to the initial calibration mode of the parametric RSSM, in the initial calibration mode of the nonparametric RSSM, a MA 110 carrying a MWD 108 traverses the floor space of the site 102 and the vector r is continuously recorded.

However, in the initial calibration mode of the nonparametric RSSM, the MA 110 does not need to traverse the entire floor space of the site 102. Rather, the MA 110 only need to pass the vicinity of each grid point along a convenient survey path. The system 100 records the RSS observables and determines the corresponding vector r (denoted as the observed RSS vector r) at the locations that the MA 110 has traversed. Then, the system 100 uses spatial interpolation to interpolate the observed RSS vectors r and obtain spatially interpolated vectors r at the grid points using the recorded RSS observables. N radio maps with the spatially interpolated vectors r are then obtained.

In some alternative embodiments, the system 100 may spatially interpolate the RSS observables and obtain interpolated vectors r for the entire floor space of the site 102 using the recorded RSS observables.

Maintenance RSSM Calibration Mode

In the maintenance calibration mode, the RSSM is calibrated during the detection and tracking of the MAs 110 and MWDs 108 by using an opportunistic crowd-sourcing method. The opportunistic crowd-sourcing method considers MAs that carry MWDs as signals of opportunity suitable for RSS calibration, and uses crowd-sourcing opportunity events for updating RSSMs. In the maintenance calibration mode, the MLS system 100 uses a process utilizing the full structure shown in FIG. 4 as there are no a priori assumptions regarding the set of MAs 110 and MWDs 108 currently in the site 102.

Maintenance Calibration of the Parametric RSSM

By using the opportunistic crowd-sourcing method, reference points are established based on the MA-MWD association, and RSS observables collected at or about the reference points are used for calibrating the RSSM parameters. However, in the maintenance calibration mode, the collected RSS observables are used to tune the RSSM parameters with the degree of tuning based on a suitable weighting method (described later; see Equations (13) and (14) and description thereabout).

In particular, the system 100 uses one or more MAs 110 isolated/detected from the ImD-captured images as the candidates for RSS crowd-sourcing. At the same time, the MWDs 108 detected within the floor space of the site 102 are tracked based on the RSS calibration values contained in the parameter vectors of cₙ currently stored in the system (denoted as stored values), which may be different to the actual values of cₙ due to environmental changes and therefore need to be calibrated. As the maintenance calibration is conducted sufficiently frequently, the difference between the stored values of cₙ and the actual values of cₙ is generally small. Therefore, tracking the MWD 108 using the stored values of cₙ is still reasonably accurate and the MWD trajectory estimate is only slightly degraded due to the relatively small error in cₙ.

The correlation of the estimates of the MWD and MA trajectories are then calculated. If the trajectories of a MWD 108 and a MA 110 are sufficiently correlated, the PoA thereof is a value close to unity and the MWD 108 is then associated with the MA 110. The position of the MA 110 calculated by the CV processing is used as the reference location which is generally more accurate compared to that of the MWD 108 calculated using RSS observables and/or position-sensing sensor observables. The vector r (see Equation (1)) related to the MWD 108 is used to adjust the parameter vector cₙ. Such adjustment is based on a suitable weighted updating method such as a moving average method such that the adjustment to cₙ based on the RSS observables currently obtained by the MWD 108 is typically small. In this way, the calibrated RSSM parameters are always based on averaging over many statistically independent RSS observables related to a common reference point, which eliminates the random effects of small-scale multipath, variances in the antenna orientation, and other non-modelled components of the RSSM, and ultimately results in a more accurate location estimate of the MWD 108.

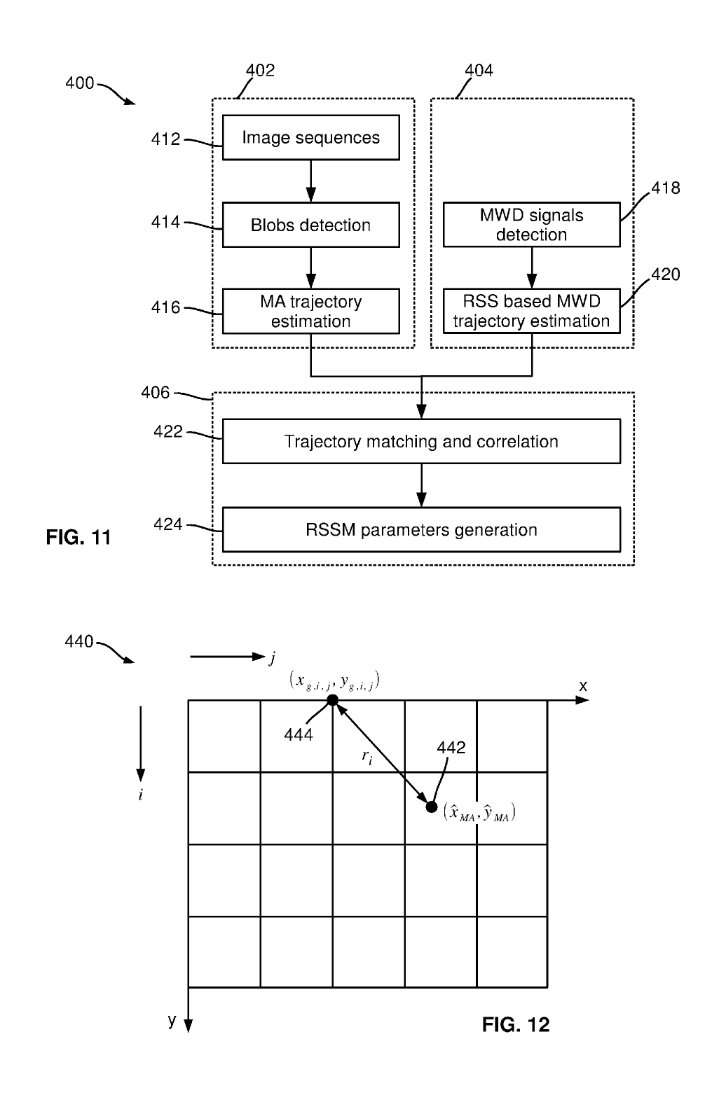

FIG. 11 is a flowchart showing the steps of a maintenance calibration process 400. As shown, the process 400 comprises (i) steps of ImD processing 402 for processing images captured by ImDs 104 to obtain the estimated trajectories of the Mas 110, (ii) steps of MWD RSS processing 404 for processing RSS observables and/or position-sensing sensor observables to obtain the vector r which is used to estimate the trajectories of MWDs 108, and (iii) steps of RSSM updating 406 for updating the parameters of RSSM.

In ImD processing 402, each ImD 104 captures a sequence of images (step 412). The captured image sequences are processed using a CV processing module for isolating blobs therein and detecting MAs 110 from isolated blobs (step 414). Then, the trajectories of detected MAs 110 are estimated (step 416). The process then goes to step 422.

The MWD RSS processing 404 is also executed in parallel with the ImD processing 402. At step 418, MWD signals are detected by for example the APs 106. At step 420, MWD positions and MWD trajectories are calculated using RSS observables and/or position-sensing sensor observables.

At step 422 of the RSSM updating 406, the MA and MWD trajectories are compared for calculating correlation and the PoA thereof. If the calculated PoA between a MA 110 and a MWD 108 is greater than a predetermined probability threshold, the MWD 108 is then associated with the MA 110, and the MA 110 and the MWD 108 are considered moving together. At step 424, some or all of the associated MAs 110 and MWDs 108 are used for updating the parameters of RSSM. For example, for a pair of associated MA 110 and MWD 108, the location of the MA 110 (determined by ImD 104 and CV processing) is used as a reference point, and the RSSM parameters are updated with the measurements in r over the observed MWD and MA trajectory (the MWD and MA trajectories merged to one trajectory as they are sufficiently correlated).

Maintenance Calibration of the Nonparametric RSSM

Crowd-sourcing is used in the maintenance calibration of the nonparametric RSSM. The process of the maintenance calibration of the nonparametric RSSM is similar to that shown in FIG. 11 for maintenance calibration of the parametric RSSM, except that, in the process of the maintenance calibration of the nonparametric RSSM, step 424 updates the radio maps.

In the maintenance calibration mode, one or more MAs 110 moving across the floor space of the site 102 are isolated in the ImD-captured images. MWDs 108 are also detected and tracked. A MA 110 and a MWD 108 are associated if their trajectories are correlated and the PoA thereof is greater than a predetermined probability threshold. After associating MWDs 108 with MAs 110, the vectors r are obtained and are used for calculating spatially interpolated vectors r at the grid points. The N radio maps are then updated with the spatially interpolated vectors r.

In the maintenance calibration mode, the parameters and radio map coefficients are adaptively tracked based on (1) selection of opportunistic events of isolated MAs, i.e., the events that one or more MAs 110 are isolated in the ImD-captured images, (2) estimation of the trajectories of the MAs 110 using CV processing, (3) estimation of the trajectories of the MWD 108 based on RSS observables and/or position-sensing sensor observables, (4) correlation of MA and MWD trajectories to associate MAs 110 and MWDs 108 with sufficiently high PoAs therebetween, and (5) interpolative update of parameters and coefficients in the RSSM based on a suitable weighting scheme (described later; see Equations (13) and (14)).

As described before, when an opportunity for calibration is available, the recorded RSS values in r as made by the MWD 108 are used in the update interpolation of the radio maps. As previously described and shown in FIG. 4, a maintenance calibration event is triggered in the mobile object tracking block 172 when an isolated MA 110 is detected in the CVOOV 168 and is paired or associated with an MWD 108 detected in the MWOOV 170 with a high PoA.

The interpolation of the observed RSS vector r into the set of RSSMs is now described. It is noted that the MA-MWD association has been established before the interpolation of the observed RSS vectors r.

As described above, the nonparametric RSSM uses a grid system (see FIG. 3) for building radio maps in which the building floor surface is partitioned into square grids with a grid spacing of Δ. Such a grid partition is used in both the CVOOV and the MWOOV processing blocks 168 and 170 (see FIG. 4). The grid points 142 are represented as (x_{g,i,j},y_{g,i,j}) with the subscript g denoting grid, i being the grid index in the y direction, and j being the grid index in the x direction. The grid spacing Δ is typically about 0.25 meters in some embodiments which is considerably smaller than the precision of the RSS signal, and thus the small-scale deviations due to small feature multipath are spatially filtered out and may not need to be taken into account in the reference model.

FIG. 12 shows an example of a portion of a 2D grid system 440 for a floor space. The radio map comprises same grids as the floor grids, and is indexed in the same way thereof. Thus, each grid of the radio map has a value denoted as R_{i,j}. Moreover, the radio map also has an ancillary array of weights W_{i,j} associated with the grid points.

For ease of illustration, FIG. 12 also shows the CV position estimate 442 of a MA 110/MWD 108 at a location (\hat{x}_{MA},ŷ_{MA}) and an arbitrary grid point 444 indexed as grid point (i,j) at a location (x_{g,i,j},y_{g,i,j}).

When a RSS measurement event occurs and an RSS reading of value Rₘ related to the MA 110/MWD 108 is received, the radio map is then updated based on Rₘ by using a radio map updating method with the following steps:

1. calculating a set of location weights using a Gaussian kernel:

w_{i,j}=exp(−α((x_{g,i,j}−\hat{x}_{MA})²+(y_{g,i,j}−ŷ_{MA})²)), (7)

where the parameter α is related to the inverse of the squared deviation of the Gaussian kernel. Typically, α has a value of about 0.5.

2. calculating or updating the radio-map weight matrix:

W_{i,j}=W_{i,j}+w_{i,j}. (8)

The radio-map weight W_{i,j} represents the effective number of RSS samples used to generate the radio map at the grid point (i,j).

The initial value of W_{i,j}, denoted as W_{i,j}⁽⁰⁾, is calculated in the initial calibration mode as:

W_{i,j}⁽⁰⁾=exp(−α((x_{g,i,j}−\hat{x}_{MA})²+(y_{g,i,j}−ŷ_{MA})²)). (9)

3. calculating or updating the radio-map value matrix:

R_{i,j}=R_{i,j}+Rₘw_{i,j}, (10)

and the value used during the normal operation of using the radio map is R_{i,j}/W_{i,j}.

The initial value of R_{i,j}, denoted as R_{i,j}⁽⁰⁾, is calculated in the initial calibration mode as:

R_{i,j}⁽⁰⁾=Rₘ×exp(−α((x_{g,i,j}−\hat{x}_{MA})²+(y_{g,i,j}−ŷ_{MA})²)), (11)

where x represents multiplication.

Those skilled in the art will appreciate that although a Gaussian kernel is used in these embodiments, other suitable spatial kernels may be alternatively used in some other embodiments.

Moreover, the kernel can be chosen such that each RSS sample influences the radio map over a wide floor area (denoted as a wide-influence kernel) which means that in embodiments using a Gaussian kernel, a small value shall be selected for the parameter α in Equation (7).

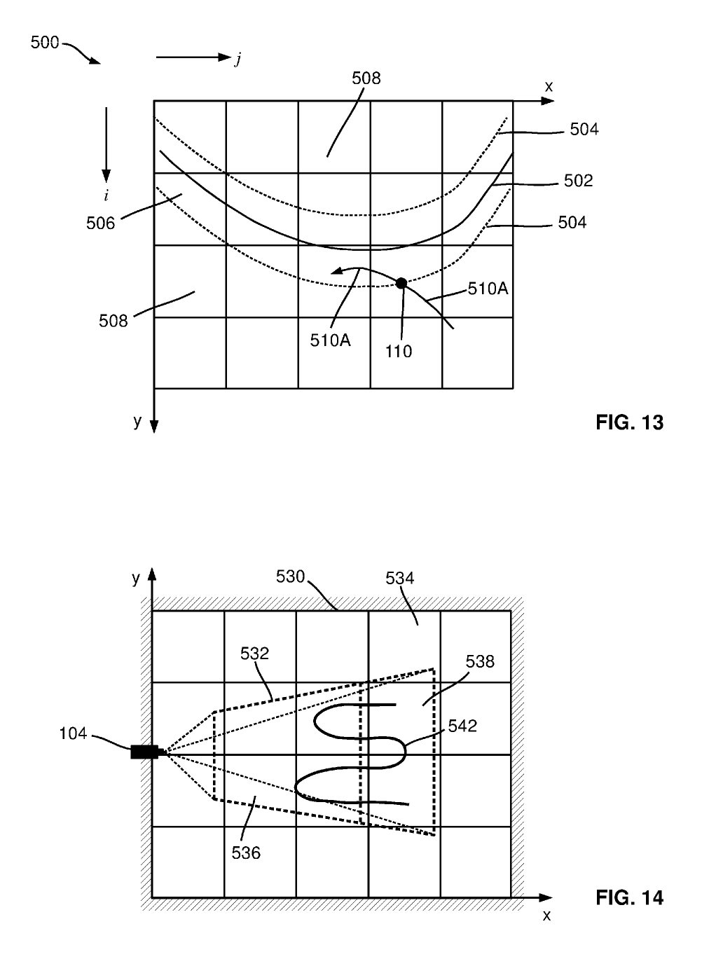

Such a wide-influence kernel gives rise to an advantage that a MA 110 carrying a MWD 108 does not need to traverse the entire floor space in the initial RSSM calibration. Rather, the MA 100 may only need to travel a portion of the floor space along a survey path such as the survey path 502 shown in FIG. 13 for an initial RSSM calibration of a floor space 500 such that, with the wide-influence kernel, the influence of the RSS samples collected along the survey path can cover the entire floor space and therefore, the RSS samples collected along the survey path can be used to build a radio map for the entire floor space. Such a radio map comprises accurate RSS information in the vicinity of the survey path that the MA 110 has travelled therealong and comprises less accurate but reasonable approximation of the RSS information elsewhere.

The RSS information accuracy of the radio map may be improved in the maintenance calibration mode by using crowd-sourced RSS data.

In some embodiments, maintenance calibration events may be triggered by crowd-sourcing opportunity events, and crowd-sourced RSS data obtained at any location of the floor space may be used for updating the RSSM and for improving the RSS information accuracy of the radio map.

In some alternative embodiments, each maintenance calibration event is triggered by a crowd-sourcing opportunity event and an additional condition that the trajectory of the CVO determined by the CVOOV is within a region where the radio-map weight W_{i,j} is greater than a given weight-acceptance threshold. The radio-map weight W_{i,j} represents the effective number of RSS samples used to generate the radio map at the grid point (i,j). Therefore, a small radio-map weight W_{i,j} implies that a small number of RSS samples are needed to generate the radio map at the grid point (i,j) and consequently, the RSS information at the grid point (i,j) may be accurate. On the other hand, a large radio-map weight W_{i,j} implies that a large number of RSS samples are needed to generate the radio map at the grid point (i,j) and consequently, the RSS information at the grid point (i,j) may be less accurate and therefore need calibration.

The weight-acceptance threshold may be predefined based on the properties of the RSSM. For example, if the environment of the floor space of the site 102 is essentially line of sight propagation, then the initial calibration conducted only along a survey path may be sufficient for the entire floor space. The weight-acceptance threshold for such a site 102 may be a small value. On the other hand, if the environment of the floor space of the site 102 is complex and the RSSM has high variability, the weight-acceptance threshold for such a site 102 may be a large value.

FIG. 13 shows a portion of a survey path 502 in a floor space 500. The dashed lines 504 are the weight-acceptance threshold lines. In a first area 506 (denoted as a non-calibration area) between the weight-acceptance threshold lines 504, the radio-map weight W_{i,j} is smaller than the weight-acceptance threshold. In a second area 508 (denoted as a calibration area) outside the weight-acceptance threshold lines (on the side of each weight-acceptance threshold line opposite to the survey path 502), the radio-map weight W_{i,j} is greater than the weight-acceptance threshold. In this example, maintenance calibration is conducted in the calibration area 508. No maintenance calibration is conducted in the non-calibration area 506.

For example, FIG. 13 shows a MA 110 that has been associated with a MWD (not shown) is moving from the calibration area 508 into the non-calibration area 506 along a trajectory which is shown in FIG. 13 as a trajectory portion 510A in the calibration area 508 and another trajectory portion 510B in the non-calibration area 506. When the MA 110 is moving in the calibration area 508 along the trajectory portion 510A, the radio-map weight W_{i,j} is greater than the weight-acceptance threshold and maintenance calibration may be conducted. However, when the MA 110 has entered the non-calibration area 506 and moves therein along the trajectory portion 510B, the radio-map weight W_{i,j} is smaller than the weight-acceptance threshold and no maintenance calibration is conducted.

Those skilled in the art will appreciate that the radio-map weight W_{i,j} is generally greater at locations of further distances to the survey path 502. Therefore, in some alternative embodiments, the MLS 100 conducts more maintenance calibrations at locations of further distances to the survey path 502.

In yet some alternative embodiments, the MLS 100 checks the radio-map weight W_{i,j}, and conducts more maintenance calibrations at locations with greater radio-map weights W_{i,j}.

Those skilled in the art appreciate that a radio map will often deteriorate (i.e., become less accurate and less reliable) over time if no update to the radio map is made or if no deliberate calibration is periodically made thereto. Therefore, in some embodiments, the MLS 100 maintains a reliability weight for each radio map. Each reliability weight has a predefined initial value such as one (1) and is periodically updated by multiplying therewith a factor having a deterioration value slightly smaller than one (1). The deterioration value may be a predefined value or alternatively, a value dynamically updated by the system based on suitable conditions such as the observed environmental change rate.

Thus, the reliability weight of each radio map decreases over time and when the reliability weight is smaller than a predefined threshold, a deliberate calibration is conducted to augment the radio map with new weighted interpolation data which also boosts W_{i,j}. Such a deliberate calibration is similar to the above-described initial calibration with the exception that the radio map is updated by a weighted combination of the existing RSSM data and the data newly obtained from the deliberate calibration. Then, the reliability weight of the radio map is reset to its initial value.

As can be seen, the RSSM is constantly evolving with repeated maintenance calibration and the deliberate calibration that may be conducted. In some embodiments, the MLS 100 uses a RSS quality factor Q_{RSS} in calculation of w_{i,j}:

w_{i,j}=Q_{RSS}exp(−α((x_{g,i,j}−\hat{x}_{MA})²+(y_{g,i,j}−ŷ_{MA})²)), (12)

where Q_{RSS} is greater than one (1) if the RSS calibration measurements are of high quality, and Q_{RSS} is smaller than one (1) if the RSS calibration measurements are of low quality. The description below explains the use of different RSS quality factor Q_{RSS} in RSSM calibration.

FIG. 14 shows an example of a rectangular room 530 with a single ImD 104. The ImD 104 has a limited FOV area 532 that only covers a portion of the room 530. Therefore, some areas 534 of the room 530 is not visible to the ImD 104 and any MA in those areas 534 is not detectable by the ImD 104.

The FOV area 532 may be partitioned into a proximal area 536 in proximity with the ImD 104 and a distal area 536 at a distance to the ImD 104. A MA in the proximal area 536 may be detectable with a projected position of high accuracy. On the other hand, a MA in the distal area 538 may merely be detectable with a projected position of low accuracy.

Correspondingly, the RSS quality factor Q_{RSS} may be set as a function of the grid index (i,j), denoted as Q_{RSS}(i,j), which may have a value greater than one (1) for grid points in the proximal area 536, and may have a value smaller than one (1) such as about 0.25 to 0.5 for grid points in the proximal area 538. The RSS quality factor Q_{RSS} in the invisible areas 534 may be set to zero (0).

For the trajectory in FIG. 13, Q_{RSS}(i,j) would be set as the interpolated values for grid points outside the main FOV area.

In an initial nonparametric RSSM calibration, a MA carrying a MWD (both not shown) travels in the room 530 along a survey path 542 to scan RSS observables for building a radio map wherein w_{i,j} is calculated using Equation (12) with the RSS quality factor Q_{RSS} being set for the proximal and distal areas 536 and 538 as described above. As the RSS quality factor Q_{RSS} in the invisible areas 534 is zero (0), the survey path 542 shall be selected within the FOV area 532.

As described above, in some embodiments, the MLS 100 calculates a Bayesian estimation of the CV trajectory of a MA 110 which uses previously estimated trajectory positions of the MA 110 to estimate the current position thereof, and incorporates the dynamics of the MA 110 into the Bayesian estimate.

In these embodiments, the MLS 100 may use the estimation of current trajectory points to refine the RSS calibration at previous trajectory points. For example, the MLS 100 may use the Bayesian covariance of the trajectory estimation at any point to determine an appropriate value for Q_{RSS}(i,j). Therefore, the RSS quality factor Q_{RSS} in the invisible areas 534 may take a nonzero value. The survey path then does not need to be entirely within the FOV area 532, and may be extendable into the invisible area 534. Moreover, the survey path does not need to traverse all grid points for building a radio map or RSSM that covers the entire floor space.

As those skilled in the art will appreciate, the location estimate of a MA 110 based on CV processing (denoted as CV-based location estimate hereinafter) is usually more accurate than that of a MWD 108 based on RSS observables and/or position-sensing sensor observables (denoted as MWD-based location estimate hereinafter). However, the CV-based location estimate of a MA 110 is less accurate when the MA 110 is at a distance to the ImD 104 such as in the distal area 538 as shown in FIG. 14.

In some embodiments, the MWD 108 is trained using the CV-based location estimate of the MA 110 associated therewith when the MA 110 is in proximity with an ImD 104. When the MA 110 moves into a distal area of the ImD 104 and the CV-based location estimate thereof becomes less accurate, the MWD-based location estimate is then used for determining the location of the MA 110.

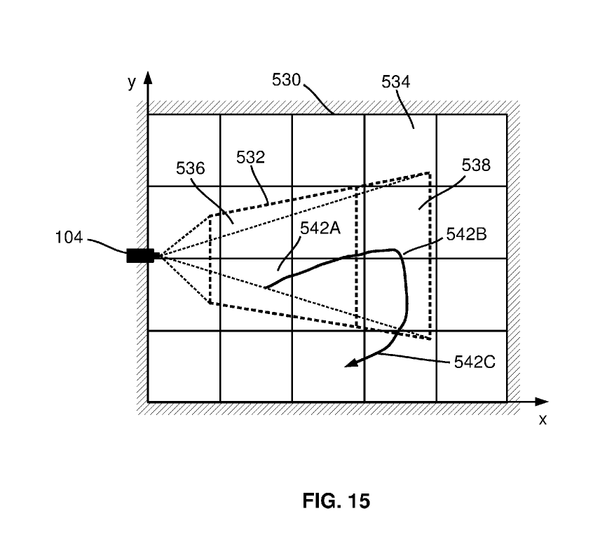

FIG. 15 shows an example wherein a MA 110 carrying a MWD 108 travels in a proximal area 536 of the FOV 532 of an ImD 104 along a first trajectory 542A, then moves into a distal area 538 of the FOV 532 along a second trajectory 542B, and eventually moves into an invisible area 534 along a third trajectory 542B. In this example, the MWD 108 comprises inertial sensors such as accelerometers and/or rate gyros, and has been associated with the MA 110.

When the MA 110 travels in the proximal area 536 along the first trajectory 542A, the CV-based location estimate thereof is accurate. The MLS uses the CV-based location estimate to train the inertial sensors of the MWD 108 to compensate for their drifts and offsets. When the MA 110 and the MWD 108 enter the distal area 538, the outputs of the inertial sensors are combined with the CV-based location estimate to obtain a location estimate of the MA 110 with improved accuracy. When the MA 110 and the MWD 108 enter the invisible area 534, MWD-based location estimate is used as the location of the MA 110.

In some embodiments, the radio-map weights W_{i,j} and RSS values R_{i,j} are updated using a suitable weighting method. When a new crowd-sourcing event occurs, there is a new trajectory component that generates w_{i,j} and r_{i,j}w_{i,j}. Then, the radio-map weights W_{i,j} and RSS values R_{i,j} are updated using a weighted combination as:

W_{i,j}=W_{i,j}+αw_{i,j}, (13)

R_{i,j}=R_{i,j}+αRₘw_{t,i,j}, (14)

where α is a weighting coefficient, and 0≦α≦1. Based on the probability law of large numbers, as calibration data is accumulated, the space variation and signal deviation in obtained radio map (i.e., the difference between the actual RSS value and that stored in the radio map at a location of the floor space and the difference due to antenna reception deviations) may be treated as an uncorrelated Gaussian noise.

In some embodiments, the MLS 100 may also use the spatial interpolated gradient components of the radio map, including the gradient of the radio map with respect to the x direction (denoted as RMx, which is the RSS data of the radio map over the discrete grid points along the x direction) and the gradient of the radio map with respect to the y direction (denoted as RMy, which is the RSS data of the radio map over the discrete grid points along they direction). RMx and RMy are calculated whenever an RSS measurement event occurs and the weight w_{i,j} and Rₘ are calculated. Then, the data matrices of

w_{x,i,j}=2α(x_{g,i,j}−\hat{x}_{MA})w_{i,j}, (15)

w_{y,i,j}=2α(y_{g,i,j}−ŷ_{MA})w_{i,j} (16)

are calculated and the stored gradient weights, denoted as W_{x,i,j} and W_{y,i,j}, are calculated as

W_{x,i,j}=W_{x,i,j}+w_{x,i,j}, (17)

W_{y,i,j}=W_{y,i,j}+W_{y,i,j}+w_{y,i,j}. (18)

The gradient radio maps are updated as

R_{x,i,j}=R_{x,i,j}+Rₘw_{x,i,j}, (19)

R_{y,i,j}=R_{y,i,j}+Rₘw_{y,i,j}. (20)

The values used during the normal operation of using the gradient components of the radio map are R_{x,i,j}/W_{x,i,j} for the gradient in x and R_{y,i,j}/W_{y,i,j} for the gradient in Y.

The initial values of W_{x,i,j} and W_{y,i,j}, denoted as W_{x,i,j}⁽⁰⁾ and W_{y,i,j}⁽⁰⁾, are calculated in the initial calibration mode as:

W_{x,i,j}⁽⁰⁾=2α(x_{g,i,j}−\hat{x}_{MA})w_{i,j}, (21)

W_{y,i,j}⁽⁰⁾=2α(y_{g,i,j}−ŷ_{MA})w_{i,j}. ((22)

The initial values of R_{x,i,j} and R_{y,i,j}, denoted as R_{x,i,j}⁽⁰⁾ and R_{y,i,j}⁽⁰⁾, are calculated in the initial calibration mode as:

R_{x,i,j}⁽⁰⁾=2α(x_{g,i,j}−\hat{x}_{MA})w_{i,j}Rₘ, (23)

R_{y,i,j}⁽⁰⁾=2α(y_{g,i,j}−ŷ_{MA})w_{i,j}Rₘ. (24)

Monitoring of Crowd-Sourcing Progress

In some embodiments, in addition to RSSM generation, the MLS 100 also monitors the quality of the RSSMs. A measurement of the accuracy of the location estimate of the MWD is the variance of the location estimate in the x and y directions for which the Fisher Information is determined. Let the Fisher Information related to the link between the n-th AP 106 and the MWD 108 be FIₙ. Then the Fisher Information matrix (FIM) is

$${FI}_{n} ( {x}_{MWD} , {y}_{MWD} ) = [ \begin{matrix}{J}_{nxx} & {J}_{nxy} \\ {J}_{nyx} & {J}_{nyy}\end{matrix} ] , \qquad ( 25 )$$

where (x_{MWD}, y_{MWD}) are the coordinates of the MWD and the components of the FIₙ matrix are given as

$$\begin{matrix}{J}_{nxx} \approx \frac{1}{{σ}^{2}} {( \frac{\partial {r}_{n} ( {x}_{MWD} , {y}_{MWD} )}{\partial {x}_{MWD}} )}^{2} , & ( 26 ) \\ {J}_{nxy} \approx \frac{1}{{σ}^{2}} ( \frac{\partial {r}_{n} ( {x}_{MWD} , {y}_{MWD} )}{\partial {x}_{MWD}} ) ( \frac{\partial {r}_{n} ( {x}_{MWD} , {y}_{MWD} )}{\partial {y}_{MWD}} ) , & ( 27 ) \\ {J}_{nxx} \approx \frac{1}{{σ}^{2}} {( \frac{\partial {r}_{n} ( {x}_{MWD} , {y}_{MWD} )}{\partial {y}_{MWD}} )}^{2} . & ( 28 )\end{matrix}$$

Here rₙ is the RSSM value of the wireless signal link between the MWD at (x_{MWD}, y_{MWD}) and the n-th AP 106, and σ is the deviation of the RSS as measured by the MWD. Those skilled in the art will appreciate that σ mainly includes receiver noise and small-scale multipath and may also include any non-modelled components of the RSS that are averaged out in the RSSM.

Various useful metrics can be computed from the FIM of Equation (25) for providing information regarding the sufficiency of the RSS measurements with respect to the MWD location estimate within a given tolerance. In these embodiments, the RSS measurement from each AP 106 to the MWD 108 is considered statistically independent. Then the FIM of each AP 106 can simply be added to determine the overall information from all APs 106. Define the total FIM as

$$J ( {x}_{MWD} , {y}_{MWD} ) = {\sum }_{n = 1}^{N} {FI}_{n} ( {x}_{MWD} , {y}_{MWD} ) . \qquad ( 29 )$$

Define the inverse of the total FIM as

$$I ( {x}_{MWD} , {y}_{MWD} ) = {J ( {x}_{MWD} , {y}_{MWD} )}^{- 1} = [ \begin{matrix}{J}_{xx} & {J}_{xy} \\ {J}_{yx} & {J}_{yy}\end{matrix} ] . \qquad ( 30 )$$

Then, \sqrt{Iₓₓ} and \sqrt{I_{yy}} give an approximation to the deviation of the location estimate in the x and y directions of the floor grid, respectively, which is useful for the CVO and MWO pairing in the mobile object tracking as the tolerance for the trajectory correspondence can be quantified. The FIM evaluation can also be extended to a trajectory segment covering multiple RSS observations and Bayesian update steps. Hence, we can quantify the contribution of the RSS observables by each AP 106.

In some embodiments, as described in the literature, the FI of the MWD position-sensing sensors (such as an inertial measurement unit comprising accelerometers and rate gyros) can also be added in such that the total FIM includes the position-sensing sensor information. The inverse of the total FIM J is evaluated with the square root of the diagonal components approximating the trajectory deviation in the x and y grid directions (or in general along the directions of all of the state variables.)

In some embodiments, after FIₙ(x_{MWD},y_{MWD}) is evaluated, the MLS 100 can determine if there is insufficient RSS information over a section of the floor surface thereby prompting the installation of an additional AP 106 about that section.

In some embodiments, after FIₙ(x_{MWD},y_{MWD}) is evaluated, the MLS 100 can determine if the RSS information is excessive over a section of the floor surface. If so, the MLS 100 determines one or more APs 106 that contribute the least amount of information. These determined APs 106 can then be removed from the MLS 100.

In some embodiments, the contribution of a certain wireless signal to the location information can be quantified thereby prompting the installation or removal of one or more APs 106 for that wireless signal. For example, if the FIₙ(x_{MWD},y_{MWD}) is deficient, the MLS 100 may prompt installation of one or more APs 106 operating in the frequency band of that wireless signal.

Test Results

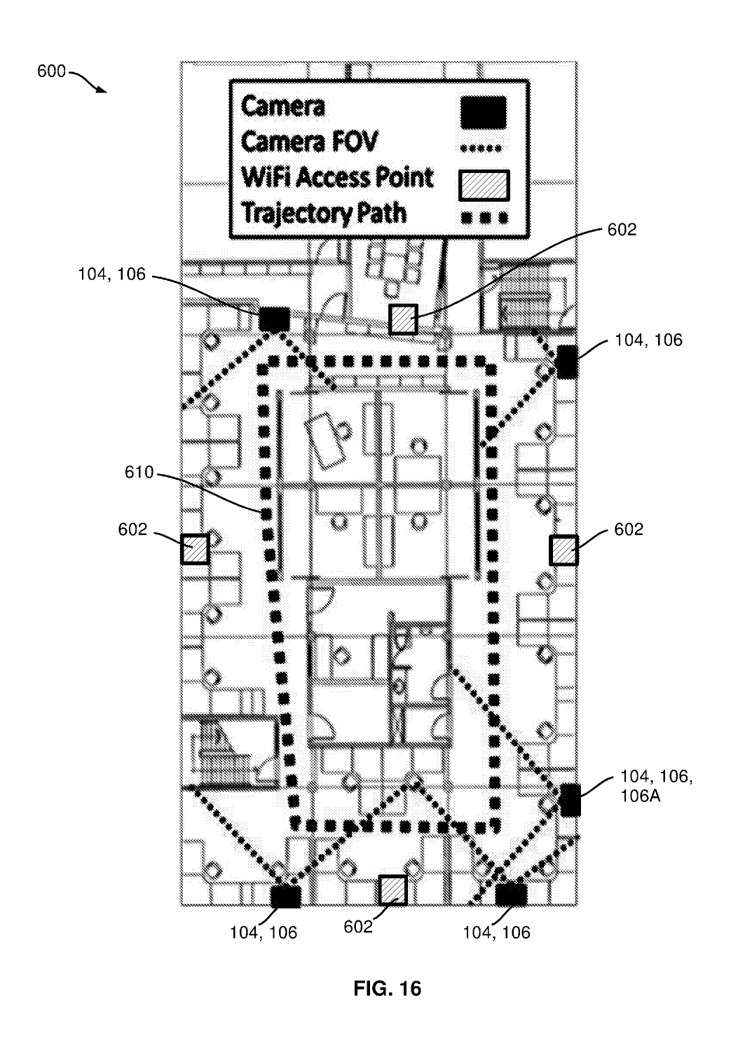

FIG. 16 is a plane view of a test floor space 600 for testing the MLS system 100 disclosed herein. As shown, the test floor space 600 comprises five (5) cameras 104. Each camera 104 comprises a Bluetooth® transceiver as the reference wireless device 106 which transmits a Bluetooth® beacon for RSS measurements and for MWD tracking. The FOV of each camera 104 is indicated in FIG. 16 using thin dotted lines.

The test floor space 600 also comprises four (4) Wi-Fi® APs 602 for wireless communication purposes which are not used for MWD tracking.

A MA 110 (not shown) carrying a tablet (not shown) travels along the survey path 610. The tablet communicates with the Bluetooth® transceiver 106 via Bluetooth® and is used as a MWD 108 that measures the RSS of the Bluetooth® beacons it receives. The tablet also communicates with a server 120 (not shown) via the Wi-Fi® APs 602 for transmitting the RSS observables to the server. The server 120 receives captured images and RSS observables from the cameras 104 and the tablet 108, respectively, and calculates the trajectory of the MA 110.

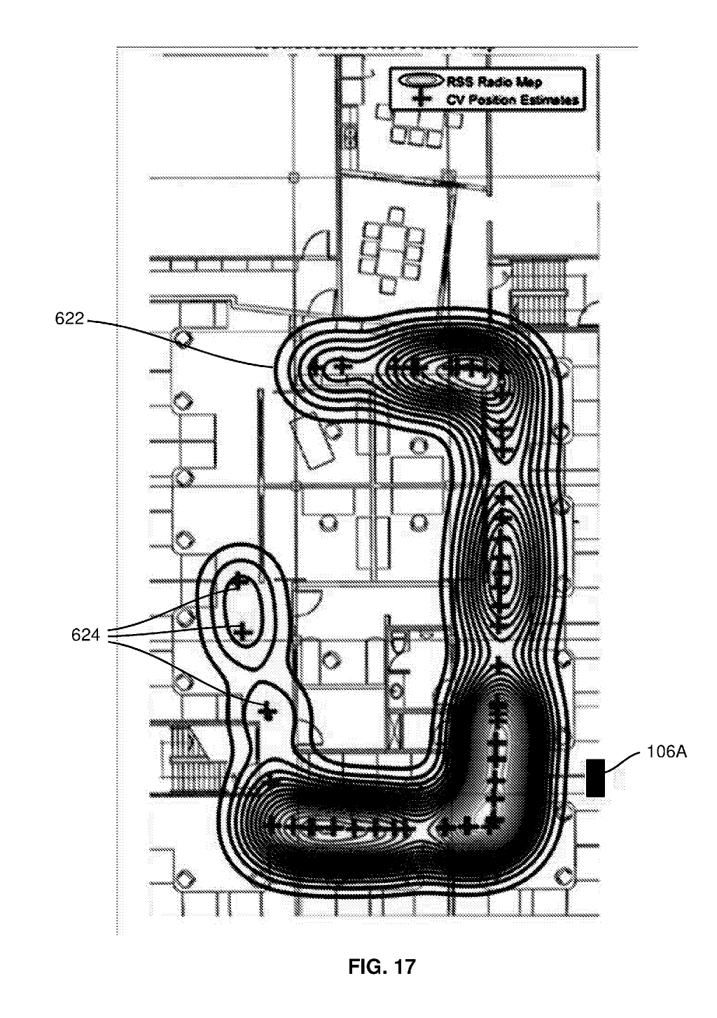

FIG. 17 is a contour plot showing the contour 622 of the radio-map weights W_{i,j} corresponding to the Bluetooth® beacon transmitted from the Bluetooth® transceiver 106A. The cross-marks 624 indicate the locations of the MA 110/MWD 108 along the survey path 610 (see FIG. 16) where the RSS samples were taken and processed. The value of W_{i,j} at each location depends on the proximity of the grid point (not shown) to the survey path 610 with the deviation of 2 meters selected for the weighting kernel described above. As the probability of reception of Bluetooth® advertising bursts increases with RSS, the number of processed samples is higher and therefore W_{i,j} is higher at the locations where the RSS is the largest. In the floor space furthest from the Bluetooth® beacon transceiver 106A, there were no valid RSS samples as the Bluetooth® signal level was too low to detect.

As described above, the W_{i,j} map may be used for normalizing the RSS table. In addition, the W_{i,j} map is also an indication of the effective number of samples at each grid location and thus may be used as an indication of the reliability of the RSS map. Therefore, as the initial calibration based on the single loop survey path 610 does not cover the entire floor space 600, the RSSM is generally accurate only in the vicinity of the locations having a large W_{i,j}.

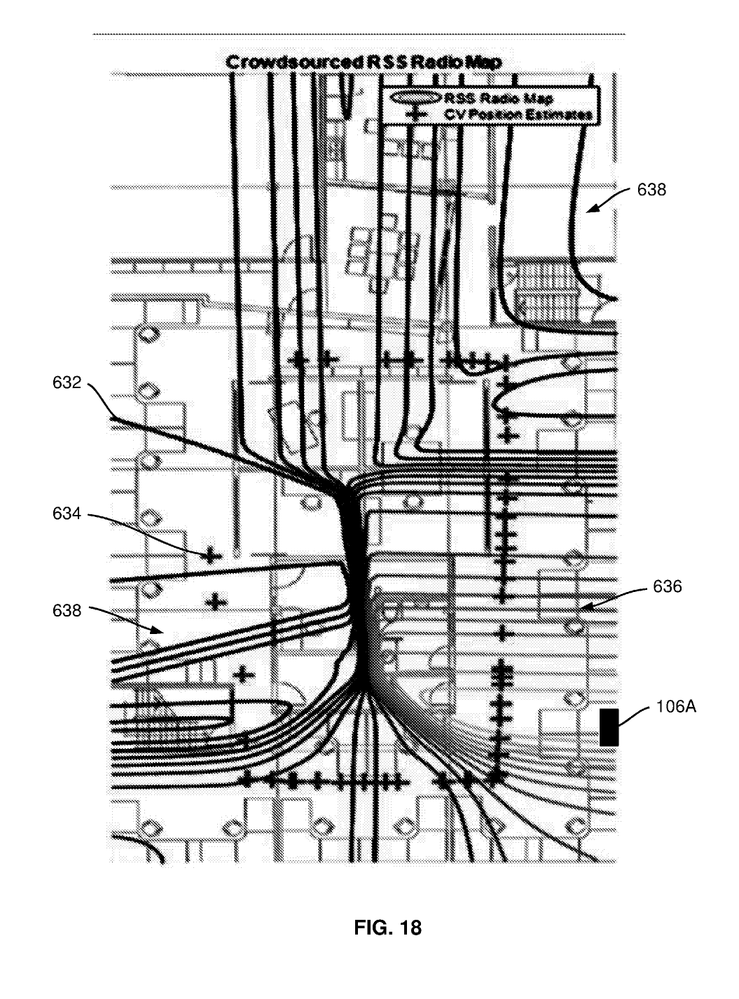

FIG. 18 is a contour plot of the radio map of the Bluetooth® beacon transmitted from the Bluetooth® beacon transceiver 106A, showing the radio map contour 632 and the locations 634 of the MA 110/MWD 108 along the survey path 610 (see FIG. 16) where the RSS samples were taken and processed. As shown, the radio map is the highest in the area 636 closest to the Bluetooth® beacon transceiver 106A and becomes negligibly small in the area 638 furthest from the Bluetooth® beacon transceiver 106A. Note that this radio map is only based on the samples taken around the perimeter of the survey path 610 and therefore is accurate only in the neighborhood thereof.

The test results shown in FIGS. 17 and 18 indicate that an exhaustive initial calibration covering the entire floor space may not be necessary. Rather, it may be sufficient for an initial calibration to build a radio map of the entire floor space by using a simple survey path with partial coverage of the floor space and a suitable kernel with the above-described kernel interpolation method. The so-built radio map at the locations where no samples were taken is usable even though it may not be highly accurate. The accuracy of the radio map may be later improved during the crowd-sourced maintenance calibration mode, which may be conducted in parallel with MA/MWD tracking. Therefore, the MLS 100 disclosed herein exhibits an advantage that the effort required for the initial calibration is significantly lowered.

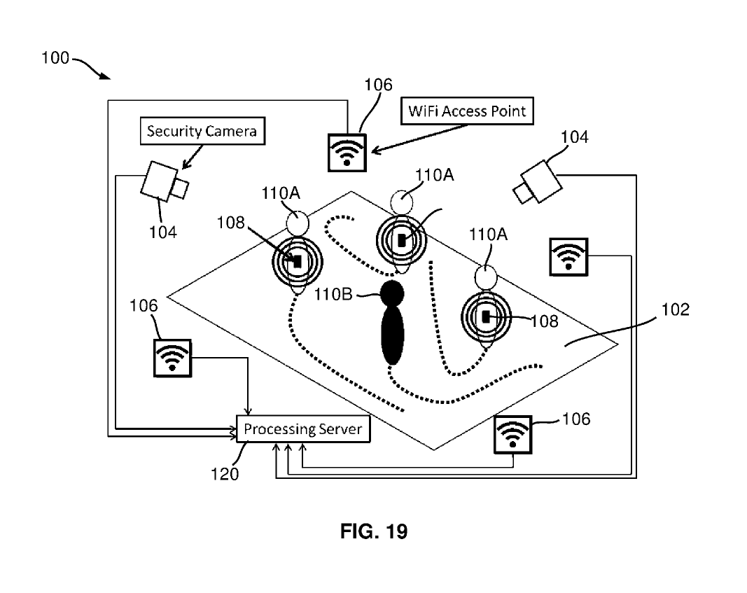

Once the initial calibration of the radio map has been completed, the maintenance calibration mode is started. FIG. 19 shows an example.

FIG. 19 shows a MLS system 100 in some alternative embodiments. As shown, the MLS system 100 comprises a plurality of ImDs 104 and a plurality of reference wireless communication devices 106 such as Wi-Fi® APs deployed in a site 102. A processing server 120 is in communication with the ImDs 104 and Wi-Fi® APs 106. In this example, an initial RSSM calibration has been conducted and one or more radio maps have been built.

A plurality of MAs 110A and 110B are movable in the site 102. The three MAs 110A each carries a MWD 108. The MA 110B does not carry any MWD. The ImDs 104 track the MAs 110A and 110B. When a MA 110A or 110B is isolated and not occluded in the images captured by an ImD 104, the isolation of the MA 110A or 110B then triggers a crowd-sourcing opportunity event. The APs 106 obtain RSS observables and send the obtained RSS observables to the processing server 120. The processing server 120 computes the MWD trajectories and correlates them with the trajectory estimates of the MAs 110.

If the MA (such as one of the MAs 110A) that triggered the crowd-sourcing opportunity event has a trajectory sufficiently correlated with a MWD trajectory, then a maintenance calibration is conducted by using the RSS observables of the correlated MWD for updating the one or more radio maps.

If, however, the trajectory of the MA (such as the MA 110B) that triggered the crowd-sourcing opportunity event does not sufficiently correlate with any MWD trajectory, the crowd-sourcing opportunity event is dismissed.

As described above, in some embodiments, if the MA (such as one of the MAs 110A) that triggered the crowd-sourcing opportunity event has a trajectory sufficiently correlated with a MWD trajectory, then the processing server 120 further obtains the radio-map weight W_{i,j} at the location of the MA 110A from the relevant radio map (see FIG. 17), and checks whether or not the radio-map weight W_{i,j} is sufficiently large such as greater than a weight threshold. If the radio-map weight W_{i,j} is sufficiently large, a maintenance calibration is conducted by using the RSS observables of the correlated MWD for updating the one or more radio maps. Otherwise, the crowd-sourcing opportunity event is dismissed.

In some embodiments, if the processing server 120 determines that during the maintenance calibration, only a small number of MAs 110 can be associated with MWDs 108 with sufficient PoA, then the processing server 120 determines that the parameters or coefficients of the RSSMs have become outdated and a deliberate calibration of the RSSMs is required.

In above embodiments, the MLS system 100 uses a single MA 110 and a single MWD 108 in the site 102 for initial RSSM calibration. However, those skilled in the art will appreciate that the initial RSSM calibration, as well as the deliberate calibration, only requires one or more pairs of associated MA 110 and MWD 108 (each with a PoA sufficiently high but not necessarily being one) that their associations are known throughout the calibration process. For example, in some embodiments, a MA 110 may comprise a unique, visual pattern that is always visible to at least one ImD 104. The MA 110 carries a MWD 108 having a unique identifier that is detectable and associated with the RSS observables of the MWD 108. The association between the MA 110 and MWD 108 is then always known to the MLS system 100. When the MLS system 100 has detected the MA 110 and MWD 108 and determines that an initial or deliberate RSSM calibration is required, the MLS system 100 may instruct the MA 110 to travel along a survey path in the site to conduct the calibration. As long as the association between the MA 110 and MWD 108 is maintained through the calibration period, the calibration generally would not be interfered by other MAs 110 and MWD 108 in the site 102.

Those skilled in the art will appreciate that the above described methods may be implemented in any suitable ways. For example, in various embodiments, the above described methods may be implemented as one or more firmware programs, one or more software programs, or a combination thereof. In some embodiments, the above described methods may be implemented as one or more electrical circuits.

Although embodiments have been described above with reference to the accompanying drawings, those of skill in the art will appreciate that variations and modifications may be made without departing from the scope thereof as defined by the appended claims.

What is claimed is:

1. A system for tracking at least one mobile object in a site, the system comprising:
one or more imaging devices each capturing images of at least a portion of the site;
one or more reference wireless devices;
one or more mobile wireless devices (MWDs) in wireless communication with the one or more reference wireless devices via one or more wireless signals, each of the one or more MWDs being associated with one of the at least one mobile object, and movable therewith; and
at least one processing structure functionally coupled to the one or more imaging devices, the one or more reference wireless devices, and the one or more MWDs, the at least one processing structure acting for:
maintaining one or more received signal strength models (RSSMs) of the site for the one or more wireless signals;
obtaining received signal strength (RSS) observables of the one or more wireless signals; and
tracking the at least one mobile object by combining the captured images, the obtained RSS observables, and the one or more RSSMs.

2. The system of claim 1 wherein each of the one or more RSSMs is any one or a combination of a parametric RSSM and a nonparametric RSSM, and wherein each nonparametric RSSM comprises a radio map of the site for one of the one or more wireless signals.

3. The system of claim 1 wherein said tracking the at least one mobile object comprises:
detecting the at least one mobile object based on the captured images;
determining a trajectory for each of the detected at least one mobile object based on the captured images;
determining a trajectory for each of the one or more MWDs based on the obtained RSSM observables and the one or more RSSMs; and
associating each of the one or more MWDs with one of the detected at least one mobile object if a probability of association (PoA) between the trajectory of the MWD and the trajectory of the mobile object is greater than a threshold.

4. The system of claim 3 wherein said determining the trajectory for each of the detected at least one mobile object based on the captured images comprises:
determining the trajectory for each of the detected at least one mobile object using a Bayesian model based on the captured images.

5. The system of claim 3 wherein the system comprises a plurality of imaging devices, at least a first and a second ones of the plurality of imaging devices are respectively associated with two main field of view (FOV) areas, and the two main FOV areas are non-overlapped with an estimation area therebetween; and wherein said determining the trajectory for each of the detected at least one mobile object based on the captured images comprises, for each of the detected at least one mobile object:
calculating the position of the mobile object by projecting the mobile object from a plane of the captured images into a coordinate system of the site;
if the calculated position of the mobile object is within the estimation area, recalculating the position of the mobile object by using a spatial interpolation method; and
determining the trajectory for the mobile object.

6. The system of claim 1 wherein the at least one processing structure further acts for:
updating the one or more RSSMs using the location of the mobile object and the RSS observables of the MWD, after associating one of the one or more MWDs with one of the at least one mobile object.

7. The system of claim 6 wherein the at least one processing structure further acts for:
identifying, from the at least one mobile object and the one or more MWDs, at least one pair of associated mobile object and MWD movable in the site, said association between each of the at least one pair of associated mobile object and MWD being maintained through a calibration period; and
building the one or more RSSMs based on the locations of the identified mobile objects and the RSS observables of the identified MWDs.

8. The system of claim 7 wherein said identifying at least one pair of associated mobile object and MWD comprises:
allowing only one of the at least one mobile object movable in the site, one of the one or more MWDs being associated with said only one mobile object and movable therewith.

9. The system of claim 7 wherein the at least one processing structure further acts for:
moving said identified at least one pair of associated mobile object and MWD in the site along a survey path.

10. The system of claim 9 wherein the site is partitioned into a two-dimensional (2D) matrix of grid points; and wherein the at least one processing structure further acts for:
calculating a set of location weights using a Gaussian kernel and the location of the mobile object;
calculating a radio-map weight matrix using the calculated set of location weights, each radio-map weight being associated with a location of the site; and
calculating a radio-map value matrix using the obtained RSSM observables obtained at the location of the mobile object.

11. The system of claim 10 wherein said updating the one or more RSSMs using the location of the mobile object and the RSS observables of the MWD comprises:
updating the one or more RSSMs using the location of the mobile object and the RSS observables of the MWD if the radio-map weight associated with the location of the mobile object is greater than a weight-acceptance threshold.

12. A method of tracking at least one mobile object in a site, the method comprising:
maintaining one or more received signal strength models (RSSMs) of the site for one or more wireless signals transmitted between one or more mobile wireless devices (MWDs) and one or more reference wireless devices, each of the one or more MWDs being associated with one of the at least one mobile object and movable therewith;
obtaining received signal strength (RSS) observables of the one or more wireless signals;
capturing images of at least a portion of the site; and
tracking the at least one mobile object by combining the captured images, the obtained RSS observables, and the one or more RSSMs.

13. The method of claim 12 wherein each of the one or more RSSMs is any one or a combination of a parametric RSSM and a nonparametric RSSM, and wherein each nonparametric RSSM comprises a radio map of the site for one of the one or more wireless signals.

14. The method of claim 12 wherein said tracking the at least one mobile object comprises:
detecting the at least one mobile object based on the captured images;
determining a trajectory for each of the detected at least one mobile object based on the captured images;
determining a trajectory for each of the one or more MWDs based on the obtained RSSM observables and the one or more RSSMs; and
associating each of the one or more MWDs with one of the detected at least one mobile object if a probability of association (PoA) between the trajectory of the MWD and the trajectory of the mobile object is greater than a threshold.

15. The method of claim 14 wherein said determining the trajectory for each of the detected at least one mobile object based on the captured images comprises:
determining the trajectory for each of the detected at least one mobile object using a Bayesian model based on the captured images.

16. The method of claim 14 wherein said determining the trajectory for each of the detected at least one mobile object based on the captured images comprises, for each of the detected at least one mobile object:
calculating the position of the mobile object by projecting the mobile object from a plane of the captured images into a coordinate system of the site;
determining if the calculated position of the mobile object is within an estimation area between two non-overlapped main field of view (FOV) areas;
if the calculated position of the mobile object is within the estimation area, recalculating the position of the mobile object by using a spatial interpolation method; and
determining a trajectory for the mobile object.

17. The method of claim 12 further comprising:
updating the one or more RSSMs using the location of the mobile object and the RSS observables of the MWD, after associating one of the one or more MWDs with one of the at least one mobile object.

18. The method of claim 17 further comprising:
identifying, from the at least one mobile object and the one or more MWDs, at least one pair of associated mobile object and MWD movable in the site, said association between each of the at least one pair of associated mobile object and MWD being maintained through a calibration period; and
building the one or more RSSMs based on the locations of the identified mobile objects and the RSS observables of the identified MWDs.

19. The method of claim 18 wherein said identifying at least one pair of associated mobile object and MWD comprises:
allowing only one of the at least one mobile object movable in the site, one of the one or more MWDs being associated with said only one mobile object and movable therewith.

20. The method of claim 18 further comprising:
moving said identified at least one pair of associated mobile object and MWD in the site along a survey path.
